(19) United States
(12) Patent Application Publication
(10) Pub. No.: US 2023/0342589 A1
(43) Pub. Date: Oct. 26, 2023

(54) ENSEMBLE MACHINE LEARNING WITH RESERVOIR NEURAL NETWORKS

(71) Applicant: X Development LLC, Mountain View, CA (US)

(72) Inventors: Sarah Ann Laszlo, Mountain View, CA (US); Julia Renee Watson, Toronto (CA); Garrett Raymond Honke, Mountain View, CA (US); Estefany Kelly Buchanan, New York, NY (US); Hailey Anne Trier, Shreveport, LA (US); Grayr Bleyan, Woodside, CA (US); Blair Armstrong, Ontario (CA); Rebecca Dawn Finzi, Menlo Park, CA (US)

(21) Appl. No.: 17/728,398

(22) Filed: Apr. 25, 2022

(51) Int. Cl. G06N 3/04; G06N 20/20; G06K 9/62

(52) U.S. Cl. CPC G06N 3/0454; G06N 20/20; G06K 9/6215; G06K 9/6227; G06K 9/6262

(57) ABSTRACT

Methods, systems, and apparatus, including computer programs encoded on a computer storage medium, for executing ensemble models that include multiple reservoir computing neural networks. One of the methods includes executing an ensemble model comprising a plurality of reservoir computing neural networks, the ensemble model having been trained by operations comprising, at each training stage in a sequence of training stages: obtaining a current ensemble model that comprises a plurality of current reservoir computing neural networks; determining a respective performance measure for each current reservoir computing neural network in the current ensemble model; determining one or more new reservoir computing neural networks to be added to the current ensemble model based on the performance measures for the current reservoir computing neural networks; and adding the new reservoir computing neural networks to the current ensemble model.

### BACKGROUND

This specification relates to processing data using machine learning models. Machine learning models receive an input and generate an output, e.g., a predicted output, based on the received input. Some machine learning models are parametric models and generate the output based on the received input and on values of the parameters of the model.

Some machine learning models are deep models that employ multiple layers of computational units to generate an output for a received input. For example, a deep neural network is a deep machine learning model that includes an output layer and one or more hidden layers that each apply a non-linear transformation to a received input to generate an output.

### SUMMARY

This specification describes systems implemented as computer programs on one or more computers in one or more locations for executing an ensemble model that includes multiple reservoir computing neural networks. This specification also describes systems for training an ensemble model that includes multiple reservoir computing neural networks.

The ensemble model can be trained using an evolutionary process that iteratively adds new reservoir computing neural networks to the ensemble model and/or removes reservoir computing neural networks from the ensemble model according to the performance of the reservoir computing neural networks in the ensemble model.

In some implementations, one or more of the reservoir computing neural networks are brain emulation reservoir computing neural networks. The parameters of the brain emulation reservoir computing neural networks of the ensemble model can be determined using a synaptic connectivity graph. A synaptic connectivity graph refers to a graph representing the structure of biological connections (e.g., synaptic connections or nerve fibers) between neuronal elements (e.g., neurons, portions of neurons, or groups of neurons) in the brain of a biological organism, e.g., a fly. For example, the synaptic connectivity graph can be generated by processing a synaptic resolution image of the brain of a biological organism.

For convenience, throughout this specification, an artificial neural network layer whose parameters have been determined using biological connectivity is called a “brain emulation” neural network layer. For convenience and to distinguish from brain emulation neural network layers, this specification refers to neural network layers whose parameters have not been determined using biological connectivity as “non-biological” neural network layers. The parameters of a non-biological neural network layer can be determined using supervised learning (e.g., backpropagation and gradient descent), unsupervised learning, or reinforcement learning, to name just a few examples. In some implementations, the parameters of a brain emulation neural network layer of a neural network are also updated during training of the neural network. That is, initial values for the parameters of the brain emulation neural network layer can be determined using biological connectivity, and those initial values can be updated using machine learning techniques.

In this specification, an artificial reservoir computing neural network having at least one brain emulation neural network layer is called a “brain emulation” reservoir computing neural network. Identifying an artificial reservoir computing neural network as a “brain emulation” reservoir computing neural network is intended only to conveniently distinguish such neural networks from other neural networks (e.g., with hand-engineered architectures), and should not be interpreted as limiting the nature of the operations that can be performed by the neural network or otherwise implicitly characterizing the neural network.

Similarly, in this specification, a reservoir subnetwork of an artificial reservoir computing neural network that includes at least one brain emulation neural network layer is called a “brain emulation” reservoir subnetwork, while reservoir subnetworks that do not include any brain emulation neural network layers are called “non-biological” reservoir subnetworks.

In this specification, the non-biological neural network layer immediately preceding a brain emulation reservoir subnetwork in the architecture of a reservoir computing neural network, and the non-biological neural network layer immediately following the brain emulation reservoir subnetwork in the architecture of the reservoir computing neural network, are called “connectivity” neural network layers. In some implementations, for each of one or more connectivity neural network layers of a neural network, the connectivity neural network layer divides the layer input to the connectivity neural network layer into multiple different channels, and processes each channel using one or more sub-layers of the connectivity neural network layer. Each sub-layer of a connectivity neural network layer can process a proper subset of the channels of the layer input to generate a respective channel of the layer output of the connectivity neural network layer. This process can significantly reduce the number of computations executed by the connectivity neural network layer compared to a fully-connected neural network layer. This process is described in more detail below with reference to FIG. 5.

In this specification, a “channel” of a first array of values is another array of values that includes a proper subset of the values of the first array. For example, if the first array is an N-dimensional array of values, then a channel of the first array can be an array that has at most N dimensions. In some implementations, a channel of an array includes a contiguous proper subset of the values of the array, i.e., each value in the channel is adjacent, within the array, to at least one other value in the channel.

Particular embodiments of the subject matter described in this specification can be implemented so as to realize one or more of the following advantages.

Using techniques described in this specification, a system can train and deploy an ensemble model that is configured to perform a machine learning task and that includes multiple reservoir computing neural networks. Using an ensemble of multiple reservoir computing neural networks can improve the performance of the ensemble model relative to using a single reservoir computing neural network, because the multiple reservoir computing neural networks can be configured through training to extract different information from the model inputs that is useful for the machine learning task. For example, given a particular input, one or more of the multiple reservoir computing neural networks may generate an incorrect prediction, but collectively it is significantly more likely that the multiple reservoir computing neural networks can generate the correct prediction.

The reservoir computing neural networks of the ensemble model can be determined by training the ensemble model using an evolutionary process that improves the performance of the ensemble model by iteratively adding new reservoir computing neural networks to the ensemble model and/or removing reservoir computing neural networks. For example, a training system can add new reservoir computing neural networks that are similar to existing reservoir computing neural networks whose performance on the machine learning task is strong. Thus, the training system can improve the performance of the ensemble model by ensuring that the ensemble model is composed of the high-performing reservoir computing neural networks.

Reservoir computing neural networks include untrained network parameters that are established before training of the rest of the network parameters. A reservoir computing neural network can thus require much less time and computational resources to train than another neural network of equivalent size that includes only trained network parameters; thus, the systems described herein can significantly improve training efficiency relative to ensemble models that include multiple neural networks with only trained network parameters.

In some implementations, the ensemble model includes one or more brain emulation reservoir computing neural networks. As described in this specification, brain emulation reservoir computing neural networks can achieve a higher performance (e.g., in terms of prediction accuracy) than other reservoir computing neural networks of an equivalent or greater size (e.g., in terms of number of parameters).

The presence of a brain emulation reservoir subnetwork in the architecture of a neural network can significantly reduce the amount of time required to train the neural network. That is, the amount of time required to train a reservoir computing neural network that includes a brain emulation reservoir subnetwork to achieve a particular performance can be significantly less than the time required to train another reservoir computing neural network that includes only non-biological reservoir subnetworks. For example, inserting a brain emulation reservoir subnetwork into the architecture of a reservoir computing neural network can reduce the amount of time required to achieve a particular performance by 100×, 1000×, or 10,000×.

In particular, in some implementations described in this specification, a system can train a brain emulation reservoir computing neural network using only one or a few parameter updates. That is, the system can process training examples using the brain emulation reservoir computing neural network to generate respective training outputs, and determine a single parameter update from an error of the training outputs; after the single parameter update, the brain emulation reservoir computing neural network can achieve a higher performance than some other reservoir computing neural networks that require thousands or millions of parameter updates. In some other implementations, the system can train the brain emulation reservoir computing neural network to achieve high performance in fewer than ten, fewer than a hundred, or fewer than a thousand parameter updates.

This training efficiency can be particularly important in situations in which very little training data is available. For example, in some implementations, a brain emulation reservoir computing neural network can be trained using fewer than ten, fewer than thirty, fewer than fifty, or fewer than a hundred training examples.

As described above, in some implementations a connectivity neural network layer of a brain emulation neural network can divide its layer input into multiple different channels. Then, for each of multiple sub-layers of the connectivity neural network layer, the sub-layer can process a proper subset of the channels of the layer input to generate a respective channel of the layer output of the connectivity neural network layer. Such a connectivity neural network layer can be significantly more efficient, in terms of time, memory, and computations, than a fully-connected neural network layer would be at the same location in the architecture of the brain emulation reservoir computing neural network.

The systems described in this specification can implement a brain emulation reservoir computing neural network having an architecture specified by a synaptic connectivity graph derived from a synaptic resolution image of the brain of a biological organism. The brains of biological organisms may be adapted by evolutionary pressures to be effective at solving certain tasks, e.g., classifying objects or generating robust object representations, and brain emulation reservoir computing neural networks can share this capacity to effectively solve tasks. In particular, compared to other reservoir computing neural networks, e.g., with manually specified neural network architectures, brain emulation reservoir computing neural networks can require less training data, fewer training iterations, or both, to effectively solve certain tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example ensemble model inference system.

FIG. 2A, FIG. 2B, and FIG. 2C illustrate an example ensemble model training system.

FIG. 3A illustrates an example reservoir computing neural network training system.

FIG. 3B illustrates an example weight matrix of a brain emulation neural network layer determined using synaptic connectivity.

FIG. 4A illustrates an example of generating a brain emulation reservoir computing neural network based on a synaptic resolution image of the brain of a biological organism.

FIG. 4B shows an example data flow for generating a synaptic connectivity graph and a brain emulation reservoir computing neural network based on the brain of a biological organism.

FIG. 5 illustrates an example block of neural network layers that includes example connectivity neural network layers and an example brain emulation subnetwork.

FIG. 6A shows an example architecture mapping system.

FIG. 6B illustrates an example graph and an example sub-graph.

FIG. 7 is a flow diagram of an example process for training an ensemble model that includes multiple reservoir computing neural networks.

FIG. 8 is a flow diagram of an example process for generating a brain emulation reservoir computing neural network.

FIG. 9 is a flow diagram of an example process for determining an artificial neural network architecture corresponding to a sub-graph of a synaptic connectivity graph.

FIG. 10 is a block diagram of an example architecture selection system.

FIG. 11 is a block diagram of an example computer system.

Like reference numbers and designations in the various drawings indicate like elements.

### DETAILED DESCRIPTION

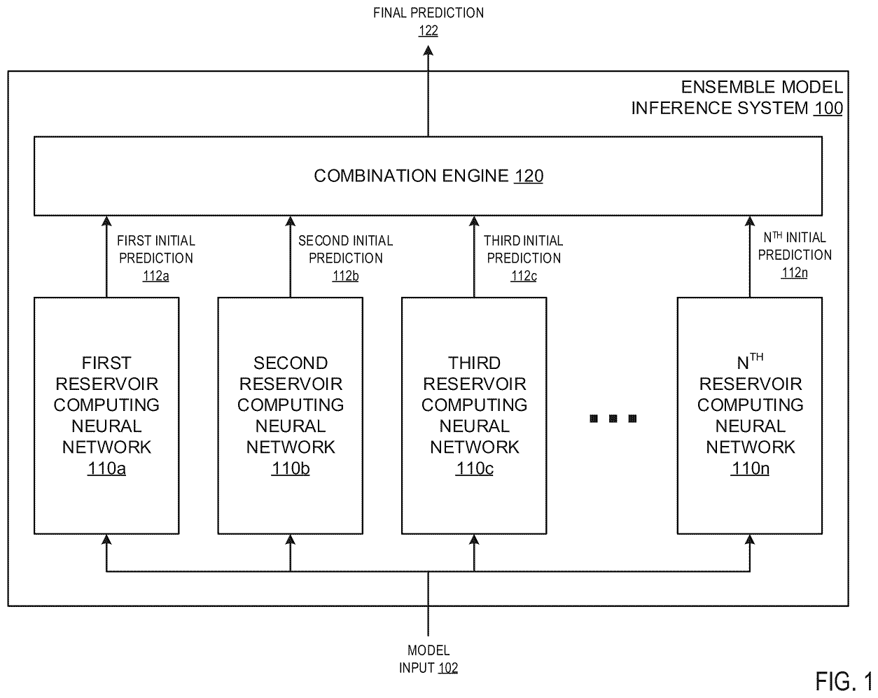

FIG. 1 shows an example ensemble model inference system 100. The ensemble model inference system 100 is an example of a system implemented as computer programs on one or more computers in one or more locations in which the systems, components, and techniques described below are implemented.

The ensemble model inference system 100 is configured to process a model input 102 using an ensemble model to generate a final prediction 122 that characterizes the model input 102. The ensemble model includes N reservoir computing neural networks 110a-n, N>1, and a combination engine 120. For example the ensemble model can include 10, 100, 500, or 1000 reservoir computing neural networks 110a-n.

Each reservoir computing neural network 110a-n is configured to process the model input 102 and to generate a respective initial prediction 112a-n that is the same type of prediction about the model input 102 as the final prediction 122. That is, the ensemble model as a whole, and each of the reservoir computing neural networks 110a-n individually, can be configured to perform the same machine learning task using the model input 102.

The combination engine 120 is configured to process the N initial predictions and to generate the final prediction 122. For example, the combination engine 120 can determine the final prediction 122 to be the average of the initial predictions 112a-n.

As another example, the combination engine 120 can determine the final prediction 122 to be a weighted sum of the initial predictions 112a-n. In some such implementations, the combination engine 120 processes the weighted sum using a nonlinear neural network layer, e.g., a softmax layer.

For instance, the combination engine 120 can combine the initial predictions 112a-n using a machine-learned weighted sum, i.e., where the weight corresponding to each initial prediction 112a-n has been machine-learned. The weights in the weighted sum can be learned during the training of the ensemble model, as described in more detail below with reference to FIGS. 1B and 1C. Described another way, the combination engine 120 can include an “output” neural network layer that is configured to apply an N-dimensional learned weight tensor (with a respective network parameter corresponding to each initial prediction 112a-n) to the initial predictions 112a-n to generate the final prediction 122.

Generally, the combination engine 120 can include a sequence of multiple neural network layers configured to process the initial predictions 112a-n to generate the final prediction 122. For convenience, the neural network layers of a combination engine can be called “combination” neural network layers. For instance, the combination engine 120 can include one or more self-attention neural network layers configured to apply a self-attention mechanism to the initial predictions 112a-n. Instead or in addition, the combination engine 120 can include one or more convolutional neural network layers that are each configured to apply a convolutional kernel to the initial predictions 112a-n. As a particular example, if each initial prediction 212a-n has size M₁×M₂, then the combination engine 120 can generate a layer input of size M₁×M₂×N where each initial prediction 212a-n is a respective channel of the layer input, and process the layer input using a convolutional kernel of size P₁×P₂×N, where M₁≥P₁ and M₂≥P₂. Instead or in addition, the combination engine 120 can include one or more feedforward neural network layers that are configured to process a layer input that includes each initial prediction 112a-n (e.g., flattened versions of the initial predictions 112a-n).

Each reservoir computing neural network 110a-n can include one or more respective reservoir subnetworks that are untrained, i.e., that include one or more neural network layers that have network parameters whose values have not been determined by training. For example, the value for the network parameters of a reservoir subnetwork can be randomly sampled from a distribution, e.g., a Normal distribution.

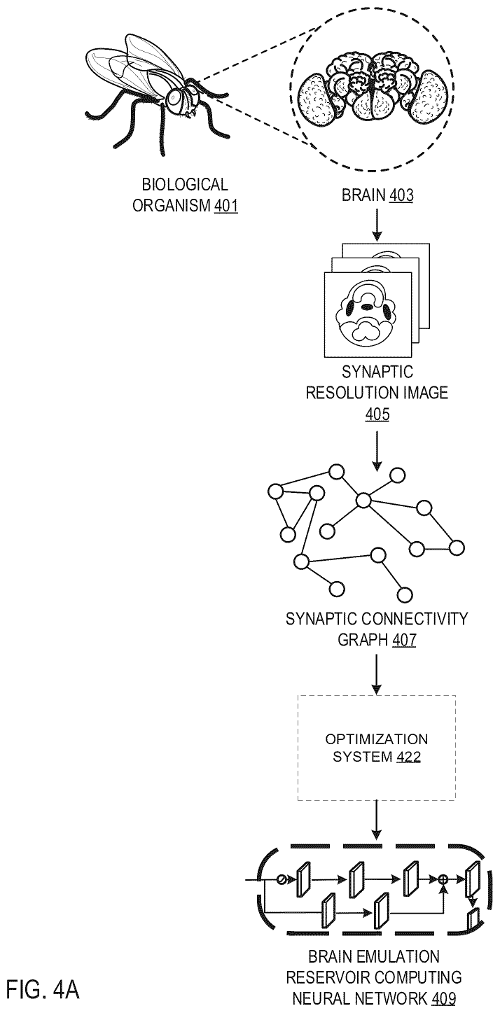

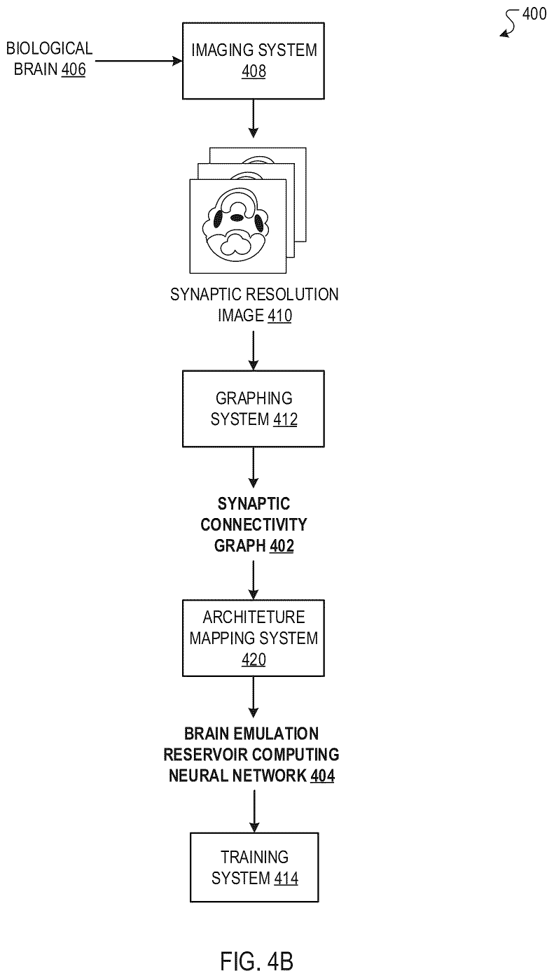

As another example, the value for the network parameters of a reservoir subnetwork can be determined using the biological connectivity between neuronal elements in the brain of a biological organism. That is, at least one of the reservoir computing neural networks 110a-n can include a reservoir subnetwork that is a brain emulation reservoir subnetwork (i.e., at least one of the reservoir computing neural networks 110a-n can be brain emulation reservoir computing neural networks). The brain emulation reservoir subnetwork can have an architecture that is based on a synaptic connectivity graph representing the biological connectivity between the neuronal elements in the brain of the biological organism, e.g., synaptic connectivity between neurons in the brain of the biological organism. In some implementations, the architecture of the brain emulation reservoir subnetwork can be specified by the synaptic connectivity between neuronal elements of a particular type in the brain, e.g., neuronal elements from the visual system or the olfactory system. An example process for determining a network architecture using a synaptic connectivity graph is described below with reference to FIG. 4A.

In some implementations, one or more of the reservoir computing neural networks 110a-n also include one or more respective trained subnetworks, i.e., that include one or more neural network layers that have network parameters whose values have been determined by training.

For example, a reservoir computing neural network 110a-n can include an input connectivity neural network layer that is a non-biological neural network layer directly preceding the reservoir subnetwork of the reservoir computing neural network 110a-n. The input connectivity neural network layer can be configured to process the model input 102 (or an intermediate representation of the model input 102) and to generate a reservoir subnetwork input for the reservoir subnetwork.

The reservoir subnetwork input can have a predefined dimensionality, e.g., a dimensionality required by the neural network architecture of the reservoir subnetwork (e.g., as required by the brain emulation neural network architecture of the brain emulation reservoir subnetwork determined using biological connectivity). The input connectivity neural network layer can be configured to project the model input 102 to the predefined dimensionality of the reservoir subnetwork input. After the reservoir computing neural network 110a-n has been trained, the input connectivity neural network layer can be configured to generate a reservoir subnetwork input that is optimized for the reservoir subnetwork, e.g., that encodes maximal information from the model input 101 that is usable by the reservoir subnetwork.

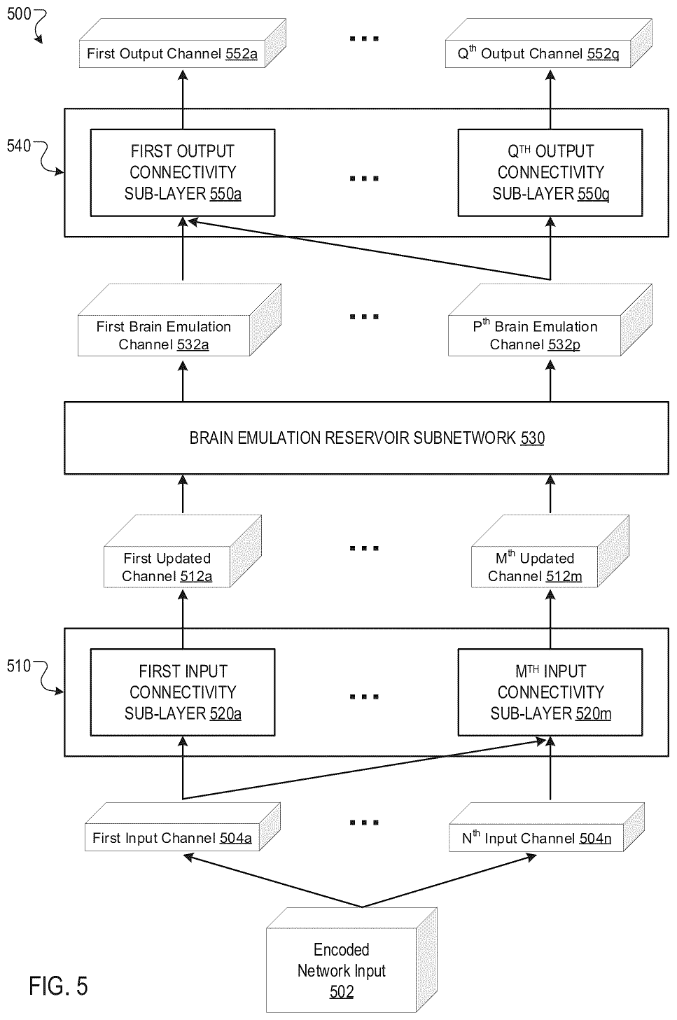

In some implementations, the input connectivity neural network layer is a fully-connected neural network layer. That is, each element of the model input 102 can be used to generate each element of the reservoir subnetwork input. In some other implementations, the input connectivity neural network layer divides the model input 102 into multiple channels, and generates respective channels of the reservoir subnetwork input by processing respective proper subsets of the channels of the model input 102. That is, each element of the reservoir subnetwork input can be generated from a proper subset of the elements of the model input 102. Typically, such a connectivity neural network layer has fewer trained parameters than a fully-connected neural network, thus requiring less time to train and execute at inference. This process is described in more detail below with reference to FIG. 5.

The reservoir subnetwork of the reservoir computing neural network 110a-n can be configured to process the reservoir subnetwork input and to generate a reservoir subnetwork output, which can be processed by subsequent neural network layers in the reservoir computing neural network 110a-n to generate the corresponding initial prediction 112a-n. The reservoir subnetwork input and the reservoir subnetwork output may be represented in any appropriate numerical format, for example, as vectors or as matrices.

For example, the reservoir computing neural network 110a-n can include an output connectivity neural network layer that is a non-biological neural network layer directly following the reservoir subnetwork of the reservoir computing neural network 110a-n. The output connectivity neural network layer can be configured to process the reservoir subnetwork output and to generate the corresponding initial prediction 112a-n (or an intermediate representation that is further processed by subsequent neural network layers). The reservoir subnetwork can be configured to generate a reservoir subnetwork output that has a predefined dimensionality (e.g., a dimensionality required by the brain emulation neural network architecture of the brain emulation reservoir subnetwork determined using biological connectivity). The output connectivity neural network layer can be configured to project the reservoir subnetwork output from the predefined dimensionality of the reservoir subnetwork output to the dimensionality of the initial prediction 112a-n (or another dimensionality that is required by the reservoir computing neural network 110a-n ).

In some implementations, the output connectivity neural network layer is a fully-connected neural network layer. In some other implementations, the output connectivity neural network layer divides the reservoir subnetwork output into multiple channels, and generates respective channels of the initial prediction 112a-n by processing respective proper subsets of the channels of the reservoir subnetwork output. Generally, the input connectivity neural network layer and the output connectivity neural network layer can be the same type of neural network layer (e.g., both fully-connected neural network layers) or different types of neural network layer.

In some implementations, the ensemble model includes a block of one or more shared neural network layers preceding the reservoir computing neural networks 110a-n that is configured to process the model input 102 to generate an embedding of the model input 102. In these implementations, each reservoir computing neural network 110a-n is configured to process the embedding of the model input 102 (or both the embedding of the model input 102 and the model input 102 itself) to generate the respective initial predictions 112a-n about the model input 102.

In some implementations, the ensemble model includes a block of one or more shared neural network layers following the reservoir computing neural networks 110a-n that is configured to process each of the initial predictions 112a-n and generate a respective updated initial prediction. The combination engine 120 can then process the updated initial predictions to generate the final prediction 122. Stated differently, the reservoir computing neural networks 110a-n can be configured to generate respective different embeddings of the model input 102, and the block of shared neural network layers following the reservoir computing neural networks 110a-n can process each of the embeddings to generate the respective initial predictions 112a-n.

In some other implementations, the reservoir computing neural networks 110a-n do not share any network parameters for generating the respective initial predictions 112a-n.

The ensemble model can be configured to perform any appropriate machine learning task.

In one example, the ensemble model can be configured to perform an image processing task, where the ensemble model is configured to process a model input 102 that represents or includes an image to generate a corresponding output, e.g., a classification output, a regression output, or a combination thereof. In this specification, processing an image refers to processing the intensity values of the pixels of the image.

As a particular example, the ensemble model can be configured to process an image to generate a classification output that includes a respective score corresponding to each of multiple categories. The score for a category indicates a likelihood that the image belongs to the category. In some cases, the categories may be classes of objects (e.g., dog, cat, person, and the like), and the image may belong to a category if it depicts an object included in the object class corresponding to the category. In some cases, the categories may represent global image properties (e.g., whether the image depicts a scene in the day or at night, or whether the image depicts a scene in the summer or the winter), and the image may belong to the category if it has the global property corresponding to the category.

As another particular example, the ensemble model can be configured to process an image to generate a pixel-level classification output that includes, for each pixel, a respective score corresponding to each of multiple categories. For a given pixel, the score for a category indicates a likelihood that pixel belongs to the category. In some cases, the categories may be classes of objects, and a pixel may belong to a category if it is part on an object included in the object class corresponding to the category. That is, the pixel-level classification output may be semantic segmentation output. For instance, the ensemble model can be configured to process an image of a manufactured article and generate a prediction of whether the manufactured article has a defect, e.g., by predicting, for each pixel in the image, where the pixel depicts a defect of the manufactured article.

As another particular example, the ensemble model can be configured to process an image to generate a regression output that estimates one or more continuous variables (i.e., that can assume infinitely many possible numerical values) that characterize the image. In a particular example, the regression output may estimate the coordinates of bounding boxes that enclose respective objects depicted in the image. The coordinates of a bounding box may be defined by (x, y) coordinates of the vertices of the bounding box.

In another example, the ensemble model can be configured to process model inputs 102 that represent sequences of audio data. For example, each of multiple input elements in the model input 102 can be a raw audio sample or an input generated from a raw audio sample (e.g., a spectrogram), and the ensemble model can process the sequence of input elements to generate a final prediction 122 that includes output elements representing predicted text samples that correspond to the audio samples. That is, the ensemble model can be a “speech-to-text” neural network. As another example, each input element can be a raw audio sample or an input generated from a raw audio sample, and the ensemble model can generate a predicted class of the audio samples, e.g., a predicted identification of a speaker corresponding to the audio samples. As a particular example, the predicted class of the audio sample can represent a prediction of whether the input audio example is a verbalization of a predefined work or phrase, e.g., a “wakeup” phrase of a mobile device. In some implementations in which one or more of the reservoir subnetworks in respective reservoir computing neural networks 110a-n in the ensemble model are brain emulation reservoir subnetworks, one or more weight matrices of the brain emulation reservoir subnetworks can be generated from a subgraph of the synaptic connectivity graph corresponding to an audio region of the brain, i.e., a region of the brain that processes auditory information (e.g., the auditory cortex).

In another example, the ensemble model can be configured to process model inputs 102 that represent sequences of text data. For example, each of multiple input elements in the model input 102 can be a text sample (e.g., a character, phoneme, or word) or an embedding of a text sample, and the ensemble model can process the sequence of input elements to generate a final prediction 122 that includes output elements representing predicted audio samples that correspond to the text samples. That is, the ensemble model can be a “text-to-speech” neural network. As another example, each input element can be an input text sample or an embedding of an input text sample, and the ensemble model can generate output elements representing a sequence of output text samples corresponding to the sequences of input text samples. As a particular example, the output text samples can represent the same text as the input text samples in a different language (i.e., the ensemble model can be a machine translation neural network). As another particular example, the output text samples can represent an answer to a question posed by the input text samples (i.e., the ensemble model can be a question-answering neural network). As another example, the input text samples can represent two texts (e.g., as separated by a delimiter token), and the ensemble model can generate a network output representing a predicted similarity between the two texts. In some implementations in which one or more of the reservoir subnetworks in respective reservoir computing neural networks 110a-n in the ensemble model are brain emulation reservoir subnetworks, one or more weight matrices of the brain emulation reservoir subnetworks can be generated from a subgraph of the synaptic connectivity graph corresponding to a speech region of the brain, i.e., a region of the brain that is linked to speech production (e.g., Broca's area).

In another example, the ensemble model can be configured to process a model input 102 representing a video, e.g., as represented by a sequence of video frames. For example, each of multiple input elements in the model input 102 can be a video frame or an embedding of a video frame, and the ensemble model can process the sequence of input elements to generate a final prediction 122 representing a prediction about the video represented by the sequence of video frames. As a particular example, the ensemble model can be configured to track a particular object in each of the frames of the video, i.e., to generate a final prediction 122 that includes a sequences of output elements, where each output elements represents a predicted location within a respective video frames of the particular object. In some implementations in which one or more of the reservoir subnetworks in respective reservoir computing neural networks 110a-n in the ensemble model are brain emulation reservoir subnetworks, one or more weight matrices of the brain emulation reservoir subnetworks can be generated from a subgraph of the synaptic connectivity graph corresponding to a visual region of the brain, i.e., a region of the brain that processes visual information (e.g., the visual cortex).

In another example, the ensemble model can be configured to process a model input 102 representing a respective current state of an environment at each of one or more time points, and to generate a final prediction 122 representing action selection outputs that can be used to select actions to be performed at respective time points by an agent interacting with the environment. For example, each action selection output can specify a respective score for each action in a set of possible actions that can be performed by the agent, and the agent can select the action to be performed by sampling an action in accordance with the action scores. In one example, the agent can be a mechanical agent interacting with a real-world environment to perform a navigation task (e.g., reaching a goal location in the environment), and the actions performed by the agent cause the agent to navigate through the environment.

In this specification, an embedding is an ordered collection of numeric values that represents an input in a particular embedding space. For example, an embedding can be a vector of floating point or other numeric values that has a fixed dimensionality.

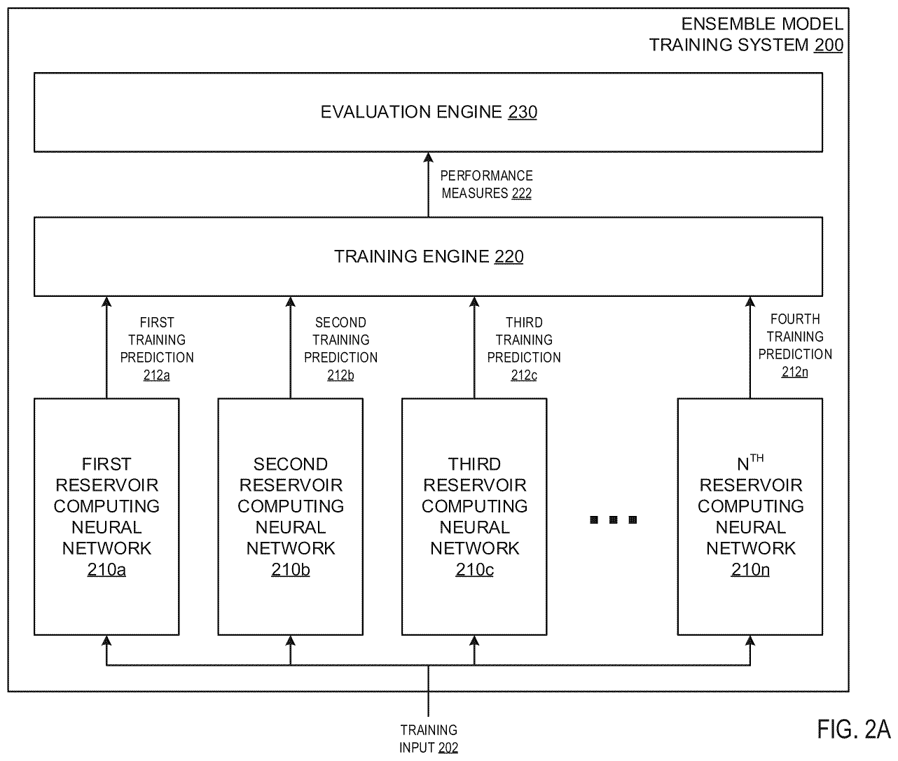

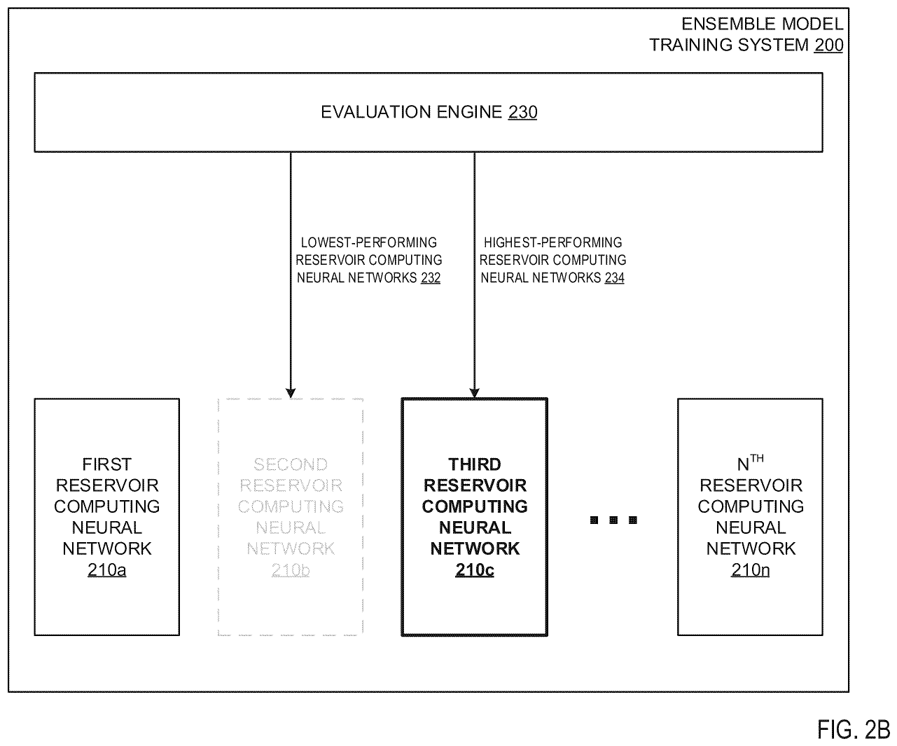

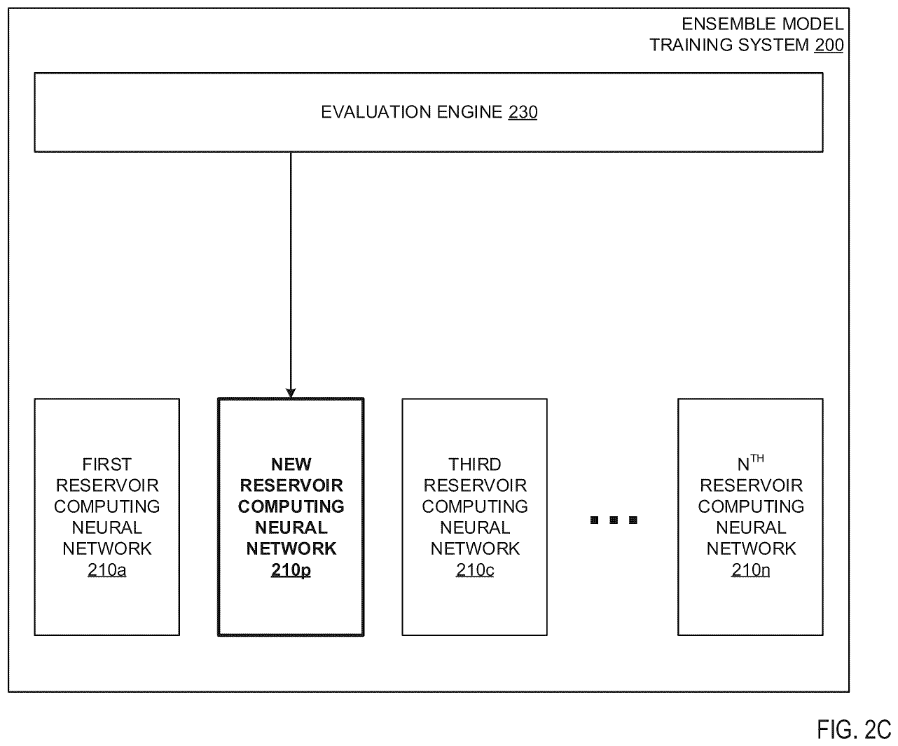

FIG. 2A, FIG. 2B, and FIG. 2C illustrate an example ensemble model training system 200.

The ensemble model training system 200 is configured to train an ensemble model that includes N reservoir computing neural networks 210a-n, N>1, to perform a machine learning task by processing a model input to generate a prediction about the model input. Each reservoir computing neural network 210a-n is configured to process the model input and to generate a respective initial prediction. The ensemble model can also include a combination engine, not shown in FIGS. 2A-2C, that is configured to process the N initial predictions and to generate the final prediction about the model input. For example, the ensemble model can be the ensemble model described above with reference to FIG. 1.

The ensemble model training system 200 is configured to train the ensemble model using an iterative, “evolutionary” process over a sequence of one or more training stages. Before the first training stage, the ensemble model training system 200 can generate an initial set of reservoir computing neural networks. Then, at each training stage in the sequence of training stages, the ensemble model training system 200 can add one or more new reservoir computing neural networks to the ensemble model. For example, as described in more detail below, the ensemble model training system 200 can determine the highest-performing reservoir computing neural networks 210a -n in the ensemble model, and add one or more new reservoir computing neural networks that are similar to the highest-performing networks 210a -n according to a similarity measure. Instead of or in addition to adding new reservoir computing neural networks to the ensemble model, in at least one of the training stages the ensemble model training system 200 can remove one or more of the reservoir computing neural networks 210a -n from the ensemble model. For example, as described in more detail below, the ensemble model training system 200 can determine the lowest-performing reservoir computing neural networks 210a -n in the ensemble model, and remove the lowest-performing reservoir computing neural networks 210a -n from the ensemble model.

This procedure is referred to as “evolutionary” because it simulates, across the multiple training stages, the removal of “weak” reservoir computing neural networks 210a -n and the addition of new reservoir computing neural networks 210a -n that may improve the performance of the ensemble model.

FIG. 2A, FIG. 2B, and FIG. 2C illustrate one training stage in the sequence of training stages for training the ensemble model. That is, the ensemble model training system 200 can repeat the techniques described below with reference to FIG. 2A, FIG. 2B, and FIG. 2C at each of multiple training stages. In particular, in FIG. 2A the ensemble model training system 200 determines values for the parameters of the ensemble model; in FIG. 2B the ensemble model training system 200 selects one or more reservoir computing neural networks 210a -n to remove from the ensemble model; and in FIG. 2C the ensemble model training system 200 identifies one or more new reservoir computing neural networks to add to the ensemble model.

Referring to FIG. 2A, at each training stage, the ensemble model training system 200 can determine values for the parameters of each of the reservoir computing neural networks 210a -n.

At the first training stage, the ensemble model training system 200 can generate the values for the network parameters of each reservoir computing neural network 210a -n.

Each reservoir computing neural network 210a -n can include one or more reservoir subnetworks that are untrained. At the first training stage, for each reservoir subnetwork of a respective reservoir computing neural network 210a -n, the ensemble model training system 200 can determine values for each untrained parameter in the reservoir subnetwork. For example, the ensemble model training system 200 can randomly sample the values for the network parameters of the reservoir subnetwork from a distribution, e.g., a Normal distribution. As another example, the ensemble model training system 200 can determine the values for the network parameters of the reservoir subnetwork using the biological connectivity between neuronal elements in the brain of a biological organism.

Optionally, one or more of the reservoir computing neural networks 210a -n can include one or more trained neural network layers. At the first training stage, for each trained neural network layer of a respective reservoir computing neural networks 210a -n, the ensemble model training system 200 can determine trained values for the parameters of the trained neural network layer.

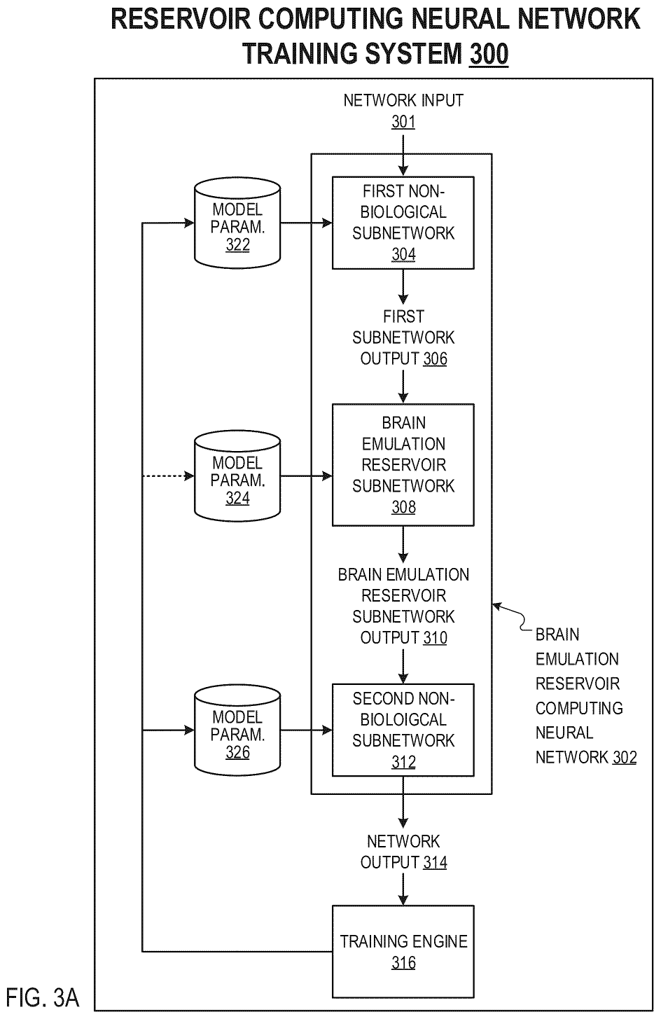

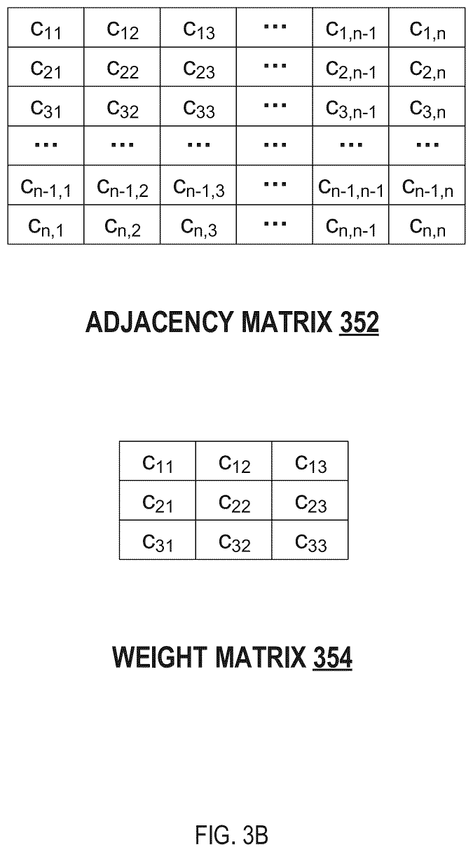

For example, for each reservoir computing neural network 210a -n that includes at least one trained neural network layer, the ensemble model training system 200 can process a training input 202 using the reservoir computing neural network 210a -n to generate a training prediction 212a-n for the training input 202. A training engine 220 of the ensemble model training system 200 can then obtain the training predictions 212a-n and determine a parameter update to the trained parameters of the reservoir computing neural network 210a -n. Training a reservoir computing neural network is discussed in more detail below with reference to FIG. 3A.

In some implementations, the ensemble model training system 200 trains each reservoir computing neural network 210a -n with at least one trained neural network layer separately, e.g., sequentially. In some other implementations, the ensemble model training system 200 trains each reservoir computing neural network 210a -n with at least one trained neural network layer concurrently, i.e., in parallel.

At each training stage after the first training stage, the ensemble model training system 200 can (i) generate the values for the network parameters of each reservoir computing neural network 210a -n added to the ensemble model at the previous training stage, and (ii) obtain the previously-generated values for the network parameters of each reservoir computing neural network 210a -n that were already in the ensemble model before the previous training stage. That is, in some implementations, the ensemble model training system 200 does not re-train reservoir computing neural networks 120a-n that were already trained during a previous training stage.

For each reservoir computing neural network 110a-n that was added to the ensemble model during the previous training stage, the ensemble model training system 200 can (i) obtain the values for the parameters of the corresponding reservoir subnetwork that was generated during the previous training stage, as described in more detail below, and (ii) train the learned neural network layers of the reservoir computing neural network 110a-n, as described above. That is, in implementations in which there are no learned neural network layers in the reservoir computing neural networks 120a-n, the ensemble model training system 200 can merely obtain the respective values for the parameters of all the reservoir computing neural networks 120a-n currently in the ensemble model.

In some implementations in which the combination engine of the ensemble model includes one or more combination neural network layers, the ensemble model training system 200 trains the one or more combination neural network layers at each training stage. For example, in implementations in which the ensemble model training system 200 combines the initial predictions of the reservoir computing neural networks 210a -n using a machine-learned weighted sum, the ensemble model training system 200 can determine the weights in the weighted sum using the training predictions 212a-n. As described in more detail below, the ensemble model training system 200 can use the learned weights in the weighted sum to identify the highest-performing and lowest-performing reservoir computing neural networks 210a -n.

For example, the ensemble model training system 200 can train the reservoir computing neural networks 210a -n and the one or more combination neural network layers concurrently end-to-end. As another example, the ensemble model training system 200 can first train the reservoir computing neural networks 210a -n and then, after determining final values for the reservoir computing neural networks 210a -n, train the combination neural network layers. In some such implementations, the ensemble model training system 200 further fine-tunes the reservoir computing neural networks 210a -n when training the combination neural network layers.

In some implementations, at each training stage after the first training stage, the ensemble model training system 200 initializes the parameters of the combination neural network layers to have the values determined at the preceding training stage. In some other implementations, the ensemble model training system 200 re-initializes the parameters of the combination neural network layers at each training stage, e.g., randomly.

In some other implementations in which the combination engine of the ensemble model includes one or more combination neural network layers, the ensemble model training system 200 does not train the combination neural network layers until after the final training stage, when the final reservoir computing neural networks 210a -n have been selected. For example, as described in more detail below, the ensemble model training system 200 can use the training accuracy or testing accuracy of each individual reservoir computing neural network 210a -n to identify the highest-performing and lowest-performing reservoir computing neural networks 210a -n. In these implementations, it is unnecessary to train the combination neural network layers until after the final reservoir computing neural networks 210a -n are selected, as the combination neural network layers are not used during the evolutionary process.

After determining the values for the parameters of the reservoir computing neural networks 210a -n, the ensemble model training system 200 can determine a respective performance measure 222 for each reservoir computing neural network 210a -n representing a predicted performance of the reservoir computing neural network 210a -n on the machine learning task that the ensemble model is configured to execute.

For example, the ensemble model training system 200 can determine the respective performance measure 222 for each reservoir computing neural network 210a -n from the performance of the reservoir computing neural network 210a -n when processing the training inputs 202 during training, e.g., the training accuracy of the reservoir computing neural network 210a -n. As another example, the ensemble model training system 200 can determine the respective performance measure 222 for each reservoir computing neural network 210a -n from the performance of the reservoir computing neural network 210a -n on a testing data set or validation data set, e.g., the accuracy of the reservoir computing neural network 210a -n on the testing data set or validation data set. In this specification, a validation data set is a subset of a training data set for a machine learning model that is held out during training of the machine learning model and used to estimate a performance of the machine learning model during training.

As another example, in implementations in which the combination engine of the ensemble model combines the initial predictions of the reservoir computing neural networks 210a -n using a machine-learned weighted sum, the ensemble model training system 200 can determine the respective performance measure 222 for each reservoir computing neural network 210a -n to be the machine-learned weight corresponding to the reservoir computing neural network in the weighted sum. Because the machine-learned weight of the reservoir computing neural network 210a -n identifies the degree to which the initial prediction of the reservoir computing neural network 210a -n contributes to the final prediction of the ensemble model, the machine-learned weight can represent the performance of the reservoir computing neural network 210a -n as determined during the training of the machine-learned weighted sum.

In some implementations, the performance measure 222 for each reservoir computing neural network 210a -n is not a scalar, but rather is multi-dimensional, e.g., includes multiple different values that each represent a respective different aspect of the predicted performance of the reservoir computing neural network 210a -n. For example, the performance measure 222 for each reservoir computing neural network 210a -n can include multiple sub-measures that each represent a predicted performance of the reservoir computing neural network 210a -n on a respective different class of model inputs. That is, from a set of model inputs that the ensemble model is configured to process, the ensemble model training system 200 can identify multiple subsets of model inputs. For example, if the ensemble model is configured to classify the model inputs, the performance measure 222 for each reservoir computing neural network 210a -n can include a respective sub-measure corresponding to each possible class to which the model inputs can be assigned, where the sub-measure corresponding to a particular class represents a predicted performance of the reservoir computing neural network 210a -n on model inputs whose ground-truth class is the particular class. For instance, the sub-measure can be the training accuracy or testing accuracy of the reservoir computing neural network 210a -n on the model inputs whose ground-truth class is the particular class.

Continuing the particular example in which the ensemble model is configured to process an image of a manufactured article and generate a prediction of whether the manufactured article has a defect, the ensemble model can be configured to classify the images into different classes corresponding to different types of defects (e.g., scratches, stains, cracks, etc.). The performance measure 222 for each reservoir computing neural network 210a -n can thus include a respective sub-measure corresponding to each type of defect identifying a performance of the reservoir computing neural network 210a -n in detecting the type of defect.

The ensemble model training system 200 can provide the performance measures 222 to an evaluation engine 230 that is configured, at each training stage, to perform the evolutionary process on the ensemble model using the performance measures 222 by (i) adding one or more new reservoir computing neural network to the ensemble model and/or (ii) removing one or more reservoir computing neural networks 210a -n from the ensemble model.

Referring to FIG. 2B, the evaluation engine 230 can use the performance measures 222 to determine the one or more lowest-performing reservoir computing neural networks 232 of the reservoir computing neural networks 210a -n currently in the ensemble model. For example, if the performance measures 222 are scalar, the evaluation engine 230 can determine the lowest-performing reservoir computing neural networks 232 to be the reservoir computing neural networks 210a -n with the lowest performance measures 222. As another example, the evaluation engine 230 can randomly sample the lowest-performing reservoir computing neural networks 232 from the reservoir computing neural networks 210a -n according to the performance measures 222, where the likelihood with which a particular reservoir computing neural network 210a -n is sampled is inversely proportional to the performance measure 222 of the particular reservoir computing neural network 210a -n.

As described above, in some implementations the performance measures 222 include multiple sub-measures corresponding to different classes of model inputs that the ensemble model is configured to process. In these implementations, the evaluation engine 230 can determine the lowest-performing reservoir computing neural networks 232 from the multiple sub-measures. For example, the evaluation engine 230 can determine the lowest-performing reservoir computing neural networks 232 to be the reservoir computing neural networks 210a -n with the lowest average sub-measure, the lowest single sub-measures, the most sub-measures below a predetermined threshold, or the fewest sub-measures above a predetermined threshold. As another example, the evaluation engine 230 can determine not to include a particular reservoir computing neural network 210a -n in the lowest-performing reservoir computing neural networks 232 if the particular reservoir computing neural network 210a -n is among the best-performing reservoir computing neural networks 210a -n for a particular class of model inputs, even if the particular reservoir computing neural network 210a -n is among the worst-performing reservoir computing neural networks 210a -n for all other classes of model inputs. In other words, some reservoir computing neural networks 210a -n can achieve a high performance for only one or a few specific classes of model input, and the evaluation engine 230 can determine to keep those reservoir computing neural networks 210a -n in the ensemble model so that the ensemble model can correctly predict the specific classes of model input.

The ensemble model training system 200 can remove the one or more lowest-performing reservoir computing neural networks 232 from the ensemble model. For example, as depicted in FIG. 2B, the evaluation engine 230 can determine the second reservoir computing neural network 210b to be one of the lowest-performing reservoir computing neural networks 232, and the ensemble model training system 200 can thus remove the second reservoir computing neural network 210b from the ensemble model.

The evaluation engine 230 can use the performance measures 222 to determine the one or more highest-performing reservoir computing neural networks 234 of the reservoir computing neural networks 210a -n currently in the ensemble model. For example, if the performance measures 222 are scalar, the evaluation engine 230 can determine the highest-performing reservoir computing neural networks 234 to be the reservoir computing neural networks 210a -n with the highest performance measures 222. As another example, the evaluation engine 230 can randomly sample the highest-performing reservoir computing neural networks 234 from the reservoir computing neural networks 210a -n according to the performance measures 222, where the likelihood with which a particular reservoir computing neural network 210a -n is sampled is directly proportional to the performance measure 222 of the particular reservoir computing neural network 210a -n.

In implementations in which the performance measures 222 include multiple sub-measures corresponding to different classes of model inputs that the ensemble model is configured to process, the evaluation engine 230 can determine the highest-performing reservoir computing neural networks 234 from the multiple sub-measures. For example, the evaluation engine 230 can determine the highest-performing reservoir computing neural networks 234 to be the reservoir computing neural networks 210a -n with the highest average sub-measure, the highest single sub-measures, the most sub-measures above a predetermined threshold, or the fewest sub-measures below a predetermined threshold.

For example, as depicted in FIG. 2B, the evaluation engine 230 can determine the third reservoir computing neural network 210c to be one of the highest-performing reservoir computing neural networks 232.

Referring to FIG. 2C, the ensemble model training system 200 can add one or more new reservoir computing neural networks to the ensemble model that are similar to the highest-performing reservoir computing neural networks 234. For example, as depicted in FIG. 2C, the ensemble model training system 200 can add a new reservoir computing neural network 210p that is similar to the third reservoir computing neural network 210c.

To add a new reservoir computing neural network 210p that is similar to one of the highest-performing reservoir computing neural networks 234 to the ensemble model, the ensemble model training system 200 generates a new reservoir subnetwork for the new reservoir computing neural network 210p that is similar to the reservoir subnetwork of the highest-performing reservoir computing neural network 234. The trained neural network layers of the new reservoir computing neural network 210p can be trained during the next training stage, as described above.

The ensemble model training system 200 can determine a new reservoir subnetwork that is similar to a particular existing reservoir subnetwork of a highest-performing reservoir computing neural network 234 in any appropriate way.

For example, the ensemble model training system 200 can determine one or more attributes of the existing reservoir subnetwork, and generate or obtain a new reservoir subnetwork that has the same or similar attributes. As a particular example, the ensemble model training system 200 can generate an attribute tensor for the existing reservoir subnetwork that includes one or more attribute values defining respective attributes of the existing reservoir subnetwork. The ensemble model training system 200 can then generate or obtain a new reservoir subnetwork for which a distance between the attribute tensor of the existing reservoir subnetwork and a corresponding attribute tensor of the new reservoir subnetwork is small.

The ensemble model training system 200 can determine similarity using any appropriate set of attributes of the respective reservoir subnetworks. For example, if the existing reservoir subnetwork is a randomly-generated reservoir subnetwork defined by a two-dimensional weight tensor (i.e., where the values for the parameters of the two-dimensional weight tensor have been randomly sampled from a distribution), then the ensemble model training system 200 can determine attributes of a graph corresponding to the existing reservoir subnetwork, where each node of the graph represents a respective row or column of the weight tensor, and each edge of the graph connecting a first node and a second node represents the value at the position of the weight tensor corresponding to the row and column of the first node and second node. As particular example, the ensemble model training system 200 can determine attributes that include one or more of: a sparsity of the graph, an average and/or maximum degree of nodes in the graph, an average and/or maximum path length between pairs of nodes in the graph, the minimum and/or maximum PageRank of the nodes of the graph, a number of cliques and/or bridges in the graph, or one or more eigenvalue statistics determined from the graph.

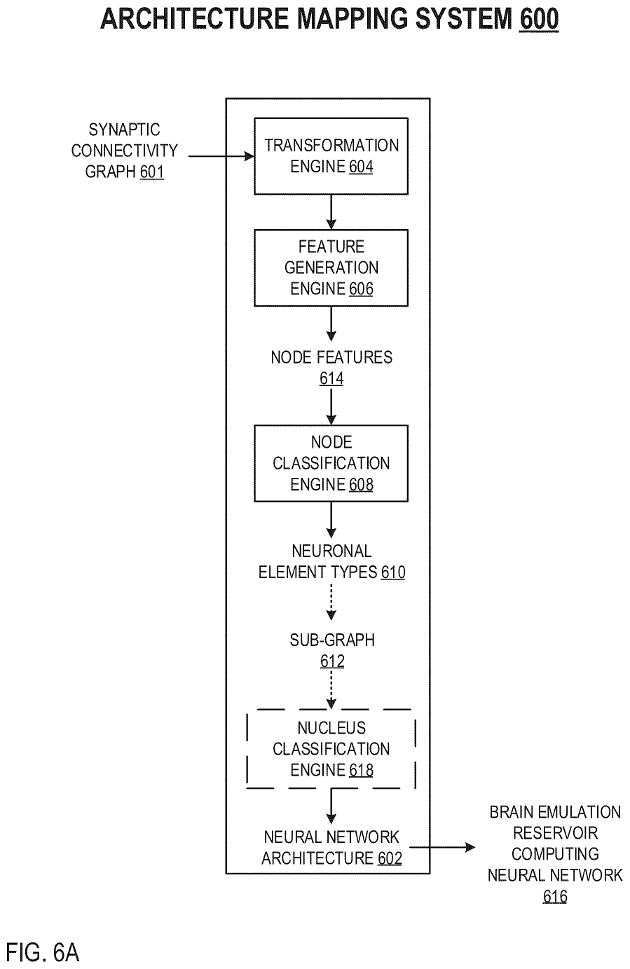

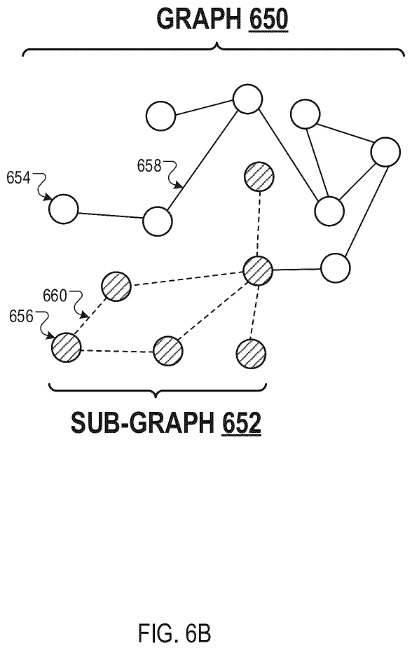

As another example, the existing reservoir subnetwork can be a brain emulation reservoir subnetwork whose parameters have been determined using the biological connectivity between neuronal elements in the brain of a biological organism. For instance, the parameters of the brain emulation reservoir subnetwork can be determined from a sub-graph of a synaptic connectivity graph representing the biological connectivity between the neuronal elements. In these implementations, the ensemble model training system 200 can determine attributes for the brain emulation reservoir subnetwork that are graph statistics of the sub-graph of the synaptic connectivity graph, as described above. Instead or in addition, the ensemble model training system 200 can determine biological attributes characterizing the biological connections and/or neuronal elements represented by the brain emulation reservoir subnetwork. As a particular example, the ensemble model training system 200 can determine a “type” of the neuronal elements represented by the brain emulation reservoir subnetwork, as described in more detail below with reference to FIG. 6A. As another particular example, the ensemble model training system 200 can determine whether the neuronal elements represented by the brain emulation reservoir subnetwork are inhibitory, excitatory, or modulatory.

In some implementations, the existing reservoir subnetwork can represent a community sub-graph of the synaptic connectivity graph, e.g., where each neuronal element represented by the community sub-graph performs the same or a similar function in the brain of the biological organism. For instance, the existing reservoir subnetwork can represent a particular community sub-graph from a set of multiple community sub-graphs determined from the synaptic connectivity graph. In these implementations, the ensemble model training system 200 can determine attributes of the particular community sub-graph represented by the existing reservoir subnetwork, e.g., attributes that characterize a relationship between the particular community sub-graph and the other community sub-graphs in the set. As a particular example, the ensemble model training system 200 can determine attributes that include one or more of: an average, maximum, or minimum PageRank of the neuronal elements in the particular community sub-graph; or the PageRank of the particular community sub-graph itself among the other community sub-graphs in the set. Community sub-graphs are discussed in more detail below with reference to FIG. 4A.

In some implementations, the ensemble model training system 200 selects the new reservoir subnetwork for the new reservoir computing neural network 210p from a set of pre-generated candidate new reservoir subnetworks. For example, before the first training stage, the ensemble model training system 200 (or an external system) can generate a set of candidate new reservoir subnetworks from which the ensemble model training system 200 can sample during the training of the ensemble model. As a particular example, the ensemble model training system 200 can randomly generate the set of candidate new reservoir subnetworks by randomly sampling, for each candidate new reservoir subnetwork in the set, the values for the parameters of the candidate new reservoir subnetwork from a distribution, e.g., the Normal distribution. As another particular example, the ensemble model training system 200 can generate a set of candidate brain emulation reservoir subnetworks from respective different sub-graphs (e.g., respective different community sub-graphs) of a synaptic connectivity graph representing biological connectivity in the brain of a biological organism. The ensemble model training system 200 can also generate a respective attribute tensor for each candidate new reservoir subnetwork in the set.

The ensemble model training system 200 can then select the new reservoir subnetwork for the new reservoir computing neural network 210p from the set of candidate new reservoir subnetworks by determining, for each candidate new reservoir subnetwork, a distance between (i) the attribute tensor characterizing the existing reservoir subnetwork and (ii) the attribute tensor characterizing the candidate new reservoir subnetwork. For example, if the attribute tensors are scalar values, then the ensemble model training system 200 can determine a difference between the attribute tensors. As another example, if the attribute tensors are multi-dimensional, then the ensemble model training system 200 can determine the Euclidean distance, cosine similarity, Hamming distance, or Manhattan distance between the attribute tensors. In some implementations, the ensemble model training system 200 selects the candidate new reservoir subnetwork with the lowest corresponding distance. In some other implementations, the ensemble model training system 200 randomly samples a candidate new reservoir subnetwork from the set according to the distances, where the likelihood that a candidate new reservoir subnetwork is selected is inversely proportional to the corresponding distance.

In some implementations in which the attribute tensors are multi-dimensional, the ensemble model training system 200 normalizes the attribute values in each attribute tensor before determining the distances, so that the distances are not disproportionally influences by any single attribute value.

In some implementations in which the reservoir subnetworks are biological connectivity reservoir subnetworks, the ensemble model training system 200 only generates the set of sub-graphs of the synaptic connectivity graph before the training of the ensemble model. Then, when determining a new reservoir computing neural network 210p that is similar to one of the highest-performing reservoir subnetworks 234, the ensemble model training system 200 (i) identifies a sub-graph from the set of generated sub-graphs that is similar to the sub-graph represented by reservoir subnetwork the highest-performing reservoir subnetwork 234, as described above, and (ii) generates a reservoir subnetwork for the new reservoir computing neural network 210p from the identified sub-graph.

In some other implementations, the ensemble model training system 200 generates the new reservoir subnetwork at the time of the training stage. For example, if the reservoir subnetworks are randomly generated, then the ensemble model training system 200 can randomly generate a set of multiple candidate new reservoir subnetworks, and select the candidate new reservoir subnetwork that is most similar to the existing reservoir subnetwork, as described above. As another example, the ensemble model training system 200 can repeatedly randomly generate candidate new reservoir subnetworks until the distance between the attribute tensor of a candidate new reservoir subnetwork and the attribute tensor if the existing reservoir subnetwork is below a predetermined threshold. As another example, the ensemble model training system 200 can randomly generate a new reservoir subnetwork under a set of constraints that require the attribute tensor of the randomly-generated new reservoir subnetwork to be below a threshold distance from the attribute tensor of the existing reservoir subnetwork.

As another example, the ensemble model training system 200 can generate a brain emulation reservoir subnetwork such that it has an attribute tensor that is similar to the attribute tensor of the existing reservoir subnetwork. For example, the ensemble model training system can determine a sub-graph of the synaptic connectivity graph that is similar to the sub-graph represented by the existing reservoir subnetwork, as described above, and generate a brain emulation reservoir subnetwork from the selected sub-graph.

In some implementations, instead of or in addition to generating new reservoir computing neural networks 210p that are similar to the highest-performing reservoir computing neural networks 234, the ensemble model training system 200 randomly generates new reservoir computing neural networks 210p, i.e., generate new reservoir computing neural networks that are not necessarily similar to the highest-performing reservoir computing neural networks 234 by randomly sampling values for the parameters of the new reservoir computing neural networks 210p from a distribution. That is, the ensemble model training system 200 can add new reservoir computing neural networks 210 according to an explore/exploit tradeoff. As a particular example, if the ensemble model training system 200 removes Q lowest-performing reservoir computing neural networks 232 from the ensemble model during a training stage, then the ensemble model training system 200 can (i) add Q/2 new reservoir computing neural networks 210p that are similar to the highest-performing reservoir computing neural networks 234, and (ii) add Q/2 randomly-generated new reservoir computing neural networks 210p. The ensemble model training system 200 can vary the explore/exploit tradeoff as the training progresses (i.e., add a different proportion of randomly-generated new reservoir computing neural network 210p at different training stages).

Although the above description refers to a training stage in which the same number of reservoir computing neural networks are removed and added to the ensemble model, generally at a given training stage the ensemble model training system 200 can remove Q₁ reservoir computing neural networks 210a -n from the ensemble model and add Q2 new reservoir computing neural networks 210p to the ensemble model, where Q₁≠Q₂ or Q₁=Q₂. In other words, the number N of reservoir computing neural networks 210a -n in the ensemble model can vary at different training stages.

Although the above description refers to a training stage in which the ensemble model training system 200 both removes reservoir computing neural networks 210a -n from the ensemble model and adds new reservoir computing neural networks 210p to the ensemble model, in some implementations, for at least one of the training stages, the ensemble model training system 200 only removes reservoir computing neural networks 210a -n from the ensemble model or only adds new reservoir computing neural networks 210p to the ensemble model. For example, in some implementations the ensemble model training system 200 only ever adds reservoir computing neural networks 210p to the ensemble model at each training stage (i.e., N increases at each training stage), and in some other implementations the ensemble model training system 200 only ever removes reservoir computing neural networks 210a -n from the ensemble model at each training stage (i.e., N decreases at each training stage).

FIG. 3A shows an example reservoir computing neural network training system 300. The reservoir computing neural network training system 300 is an example of a system implemented as computer programs on one or more computers in one or more locations in which the systems, components, and techniques described below are implemented.

The reservoir computing neural network training system 300 is configured to train a reservoir computing neural network 302. For example, the reservoir computing neural network training system 300 can be a component of a training system for an ensemble model that includes multiple different reservoir computing neural networks. In some implementations, the reservoir computing neural network training system 300 can execute to train multiple different reservoir computing neural networks in parallel. As a particular example, the reservoir computing neural network training system 300 can be a component of the training engine 220 described above with reference to FIG. 2A.

The below description refers to implementations in which the reservoir computing neural network 302 includes a brain emulation reservoir subnetwork. However, the same techniques can be applied to train reservoir computing neural networks that include non-biological reservoir subnetworks.

The reservoir computing neural network 302 can have (at least) three subnetworks: (i) a first non-biological subnetwork 304 (ii) a brain emulation reservoir subnetwork 308, and (iii) a second non-biological subnetwork 312. The reservoir computing neural network 302 is configured to process a network input 301 to generate a network output 314 that represents a prediction about the network input 301.

The first non-biological subnetwork 304 is configured to process the network input 301 in accordance with a set of model parameters 322 of the first non-biological subnetwork 304 to generate a first subnetwork output 306. The final neural network layer of the first non-biological subnetwork 304 can be a connectivity neural network layer; connectivity neural network layers are described in more detail below with reference to FIG. 5.

The brain emulation reservoir subnetwork 308 is configured to process the first subnetwork output 306 in accordance with a set of model parameters 324 of the brain emulation reservoir subnetwork 308 to generate a brain emulation reservoir subnetwork output 310. In this specification, the parameters of a brain emulation reservoir subnetwork are also called “brain emulation parameters.”

The second non-biological subnetwork 312 is configured to process the brain emulation reservoir subnetwork output 310 in accordance with a set of model parameters 326 of the second non-biological subnetwork 312 to generate the network output 314. The first neural network layer of the second non-biological subnetwork 312 can be a connectivity neural network layer.

The brain emulation reservoir subnetwork can include one or more brain emulation neural network layers whose respective architectures have been determined using biological connectivity. For example, the brain emulation reservoir subnetwork 308 can be configured similarly to the brain emulation reservoir subnetworks of the reservoir computing neural networks 110a-n described above with reference to FIG. 1.

Although the reservoir computing neural network 302 depicted in FIG. 3A includes one non-biological subnetwork 304 before the brain emulation reservoir subnetwork 308 and one non-biological subnetwork 312 after the brain emulation reservoir subnetwork 308, in general the reservoir computing neural network 302 can include any number of non-biological subnetworks before and/or after the brain emulation reservoir subnetwork 308. In some implementations, the first non-biological subnetwork 304 and/or the second non-biological subnetwork 312 can include only one or a few neural network layers (e.g., a single fully-connected layer) that processes the respective subnetwork input to generate the respective subnetwork output.

In implementations where there are zero non-biological subnetworks before the brain emulation reservoir subnetwork 308, the brain emulation reservoir subnetwork 308 can receive the network input 301 directly as input. In implementations where there are zero non-biological subnetworks after the brain emulation reservoir subnetwork 308, the brain emulation reservoir subnetwork output 310 can be the network output 314.

Although the reservoir computing neural network 302 depicted in FIG. 3A includes a single brain emulation reservoir subnetwork 308, in general the reservoir computing neural network 302 can include multiple brain emulation reservoir subnetwork 308. In some implementations, each brain emulation reservoir subnetwork 308 has the same set of brain emulation parameters 324; in some other implementations, each brain emulation reservoir subnetwork 308 has a different set of brain emulation parameters 324. In some implementations, each brain emulation reservoir subnetwork 308 has the same network architecture; in some other implementations, each brain emulation reservoir subnetwork 308 has a different network architecture.

In some implementations, the brain emulation reservoir subnetwork 308 has a recurrent neural network architecture. That is, the brain emulation reservoir subnetwork 308 can process the first subnetwork output 306 multiple times at respective time steps.

For example, the architecture of the brain emulation reservoir subnetwork 308 can include a sequence of components (e.g., brain emulation neural network layers or groups of brain emulation neural network layers) such that the architecture includes a connection from each component in the sequence to the next component, and the first and last components of the sequence are identical. In one example, two brain emulation neural network layers that are each directly connected to one another (i.e., where the first layer provides its output the second layer, and the second layer provides its output to the first layer) would form a recurrent loop. A recurrent brain emulation reservoir subnetwork 308 can process the first subnetwork output 306 over multiple time steps to generate a respective brain emulation reservoir subnetwork output 310 at each time step. In particular, at each time step, the brain emulation reservoir subnetwork 308 can process: (i) the first subnetwork output 306 (or a component of the first subnetwork output 306), and (ii) any outputs generated by the brain emulation reservoir subnetwork 308 at the preceding time step, to generate the brain emulation reservoir subnetwork output 310 for the time step. The reservoir computing neural network 302 can provide the brain emulation reservoir subnetwork output 310 generated by the brain emulation reservoir subnetwork 308 at the final time step as the input to the second non-biological subnetwork 312. The number of time steps over which the brain emulation reservoir subnetwork 308 processes the first subnetwork output 306 can be a predetermined hyper-parameter of the reservoir computing neural network training system 300.

In some implementations, in addition to processing the brain emulation reservoir subnetwork output 310 generated by the output layer of the brain emulation reservoir subnetwork 308, the second non-biological subnetwork 312 can additionally process one or more intermediate outputs of the brain emulation reservoir subnetwork 308.

The reservoir computing neural network training system 300 includes a training engine 316 that is configured to train the reservoir computing neural network 302.

In some implementations, the brain emulation parameters 324 for the brain emulation reservoir subnetwork 308 are untrained. Instead, the brain emulation parameters 324 of the brain emulation reservoir subnetwork 308 can be determined before the training of the non-biological subnetworks 304 and 312 based on the weight values of the edges in a synaptic connectivity graph representing biological connectivity between neuronal elements in the brain of a biological organism. Optionally, the weight values of the edges in the synaptic connectivity graph can be transformed (e.g., by additive random noise) prior to being used for specifying brain emulation parameters 324 of the brain emulation reservoir subnetwork 308. This procedure enables the reservoir computing neural network 302 to take advantage of the information from the synaptic connectivity graph encoded into the brain emulation reservoir subnetwork 308 in performing prediction tasks.

Therefore, rather than training the entire reservoir computing neural network 302 from end-to-end, the training engine 316 can train only the model parameters 322 of the first non-biological subnetwork 304 and the brain emulation parameters 326 of the second non-biological subnetwork 312, while leaving the brain emulation parameters 324 of the brain emulation reservoir subnetwork 308 fixed during training.

The training engine 316 can train the reservoir computing neural network 302 on a set of training data over one or more training iterations. The training data can include a set of training examples, where each training example specifies: (i) a training network input, and (ii) a target network output that should be generated by the reservoir computing neural network 302 by processing the training network input.

In some implementations, only a single training iteration is required for the reservoir computing neural network 302 to achieve a high performance, significantly reducing the time, computational cost, and monetary cost of training the reservoir computing neural network 302 relative to some existing techniques. For example, if the reservoir computing neural network 302 would have required a thousand training iterations to achieve a comparable performance if the reservoir computing neural network 302 did not include the brain emulation reservoir subnetwork 308, then the cost of training (e.g., as measured by the monetary cost of running the hardware used during training, e.g., one or more graphics processing unit (GPUs) or one or more tensor processing units (TPUs)) is reduced by 1000× by adding the brain emulation reservoir subnetwork 308 to the network architecture.

At each training iteration, the training engine 316 can sample a batch of training examples from the training data, and process the training inputs specified by the training examples using the reservoir computing neural network 302 to generate corresponding network outputs 314. In particular, for each training input, the reservoir computing neural network 302 processes the training input using the current model parameter values 322 of the first non-biological subnetwork 304 to generate a first subnetwork output 306. The reservoir computing neural network 302 processes the first subnetwork output 306 in accordance with the static brain emulation parameters 524 of the brain emulation reservoir subnetwork 308 to generate a brain emulation reservoir subnetwork output 310. The reservoir computing neural network 302 then processes the brain emulation reservoir subnetwork output 310 using the current model parameter values 326 of the second non-biological subnetwork 312 to generate the network output 314 corresponding to the training input.

The training engine 316 adjusts the model parameters values 322 of the first non-biological subnetwork 304 and the model parameter values 326 of the second non-biological subnetwork 312 to optimize an objective function that measures a similarity between: (i) the network outputs 314 generated by the reservoir computing neural network 302, and (ii) the target network outputs specified by the training examples.

For example, the objective function can be a focal loss objective function, a binary focal loss objective function, a cross-entropy objective function, a squared-error objective function, or any other appropriate objective function.

To optimize the objective function, the training engine 316 can determine gradients of the objective function with respect to the model parameters 322 of the first non-biological subnetwork 304 and the model parameters 326 of the second non-biological subnetwork 312, e.g., using backpropagation techniques. The training engine 316 can then use the gradients to adjust the model parameter values 322 and 326, e.g., using any appropriate gradient descent optimization technique, e.g., an RMSprop or Adam gradient descent optimization technique.

The training engine 316 can use any of a variety of regularization techniques during training of the reservoir computing neural network 302. For example, the training engine 316 can use a dropout regularization technique, such that certain artificial neurons of the reservoir computing neural network 302 are “dropped out” (e.g., by having their output set to zero) with a non-zero probability p>0 each time the reservoir computing neural network 302 processes a network input. Using the dropout regularization technique can improve the performance of the trained reservoir computing neural network 302, e.g., by reducing the likelihood of over-fitting. As another example, the training engine 316 can regularize the training of the reservoir computing neural network 302 by including a “penalty” term in the objective function that measures the magnitude of the model parameter values 322 and 326 of the non-biological subnetworks 304 and 312. The penalty term can be, e.g., an L₁ or L₂ norm of the model parameter values 322 of the first non-biological subnetwork 304 and/or the model parameter values 326 of the second non-biological subnetwork 312.

In some other implementations, the brain emulation parameters 324 for the brain emulation reservoir subnetwork 308 are trained. That is, after initial values for the brain emulation parameters 324 of the brain emulation reservoir subnetwork 308 have been determined based on the weight values of the edges in the synaptic connectivity graph, the training engine 316 can update the weights of the brain emulation parameters, as described above with reference to the parameters 322 and 326 of the non-biological subnetworks, e.g., using backpropagation and stochastic gradient descent.

In some implementations, the some or all of the brain emulation parameters 324 (e.g., the brain emulation parameters for a particular brain emulation neural network layer of the brain emulation reservoir subnetwork 308) are represented by a sparse weight matrix. In this specification, a matrix may be referred to as a “sparse matrix” if the sparsity of the matrix (i.e., the number or proportion of zero-value elements of the matrix) satisfies a certain threshold. For example, in some implementations the weight matrix of a brain emulation neural network layer has a sparsity of 50% (i.e., where 50% of the brain emulation parameters of the weight matrix have a value of zero), 60%, 70%, 80%, 90%, 95%, or 99%.

In some such implementations, when updating the brain emulation parameters of a sparse weight matrix, the training engine 316 keeps the zero-value elements of the sparse weight matrix constant, i.e., at zero. If the training engine 316 executed backpropagation and gradient descent across all the values of the weight matrix, zero-value brain emulation parameters of the weight matrix would likely be updated to non-zero values. Because the weight matrix represents biological connectivity between neuronal elements in the brain of a biological organism, updating a zero-value brain emulation parameter to have a non-zero value corresponds to incorrectly representing biological connectivity between the pair of neuronal elements represented by the brain emulation parameter, when no such biological connectivity was measured in the brain of the biological organism. Thus, in some implementations in which fidelity to the measured biological connectivity is important, the training engine 316 avoids inserting representations of new and incorrect biological connections by freezing the zero-value brain emulation parameters at zero.

In some other such implementations, the training engine 316 does update some or all of the zero-value brain emulation parameters of the weight matrix to have a non-zero value. Instead or in addition, the training engine 316 can update one or more non-zero brain emulation parameters of the weight matrix to have a value zero, and freeze the value at zero.

For example, the training engine 316 can execute an artificial evolutionary procedure whereby, over multiple training stages, the training engine 316 iteratively removes the brain emulation parameters representing the weakest biological connections in the brain of the biological organism from the weight matrix. The training engine 316 can also add new brain emulation parameters to the weight matrix, where the new brain emulation parameters represent “new” biological connections in the brain of the biological organism (i.e., biological connections that were not measured in the brain of the biological organism).

This procedure is referred to as “evolutionary” because it simulates, across the multiple training stages, the removal of “weak” brain emulation parameters (e.g., brain emulation parameters with the lowest value or magnitude) and the addition of new brain emulation parameters that may improve the performance of the reservoir computing neural network 302. Performing the evolutionary procedure can further reduce the amount of training data and the number of training iterations required to train the reservoir computing neural network 302 to achieve an acceptable level of performance, e.g., as measured by prediction accuracy.

For example, at each of one or more training stages during the training of the reservoir computing neural network 302, the training engine 316 can stochastically sample (i.e., select) non-zero brain emulation parameters of the weight matrix, and remove the sampled non-zero brain emulation parameters from the weight matrix.

As a particular example, the training engine 316 can sample each non-zero brain emulation parameter with a uniform likelihood. That is, each non-zero brain emulation parameter can have the same likelihood of being selected, regardless of the value of the parameter or the position of the parameter within the weight matrix. As another particular example, the training engine 316 can determine the N non-zero brain emulation parameters that have the lowest respective magnitudes, N>1, and sample the N non-zero brain emulation parameters uniformly. For instance, N can be a predetermined integer, or N can be a predetermined fraction of the total number of non-zero brain emulation parameters in the weight matrix.

As another particular example, the training engine 316 can sample each non-zero brain emulation parameter with a likelihood that is inversely proportional with the magnitude of its value. That is, non-zero brain emulation parameters with lower magnitudes can be more likely to be selected than non-zero brain emulation parameters with higher magnitudes.

In some such implementations, the training engine 316 can determine the likelihood of sampling each non-zero brain emulation parameter to be equal to the softmax of the negated magnitude of the non-zero brain emulation parameter. That is, the training engine 316 can compute:

$${p}_{i} = \frac{{e}^{- \vert {x}_{i} \vert}}{{\sum }_{j} {e}^{- \vert {x}_{j} \vert}}$$

where xᵢ is the value of the i^{th} non-zero brain emulation parameter and pᵢ is the likelihood with which the i^{th}non-zero brain emulation parameter is sampled by the training engine 316.

In some other such implementations, the training engine 316 can determine the likelihood of sampling each non-zero brain emulation parameter to be equal to the softmax of the inverse magnitude of the non-zero brain emulation parameter. That is, the training engine 316 can compute:

$${p}_{i} = \frac{{e}^{1 / \vert {x}_{i} \vert}}{{\sum }_{j} {e}^{1 / \vert {x}_{j} \vert}}$$

In some other such implementations, the training engine 316 can determine the N non-zero brain emulation parameters that have the lowest respective magnitudes, N>1, and sample the N non-zero brain emulation parameters according to either of the softmax equations described above.

As another particular example, the training engine 316 can sample each represented brain emulation parameter with a likelihood that is inversely proportional to the rank of the non-zero brain emulation parameter in a ranking of the non-zero brain emulation parameters of the weight matrix. That is, non-zero brain emulation parameters with lower ranks in the ranking of the magnitudes can be more likely to be selected than non-zero brain parameters with higher ranks in the ranking of the magnitudes. In some such implementations, the training engine 316 can determine the N non-zero brain emulation parameters that have the lowest respective ranks in the ranking of the magnitudes, N>1, and sample the N non-zero brain emulation parameters according to their respective ranks.

As another example, the training engine 316 can execute a two-step process for stochastically sampling the non-zero brain emulation parameters of the weight matrix. In the first step of the two-step process, the training engine 316 can generate a set of candidate non-zero brain emulation parameters by sampling the non-zero brain emulation parameters according to a ranking of their magnitudes. In the second step of the two-step process, the training engine 316 can sample from the set of non-zero brain emulation parameters according to their magnitudes (e.g., using a softmax function as described above). The training engine 316 can then remove the candidate non-zero brain emulation parameters sampled in the second step from the weight matrix.

In some implementations, the training engine 316 removes the same number of non-zero brain emulation parameters at each training stage. In some other implementations, the training engine 316 can sample a different number of non-zero brain emulation parameters at each training stage.

Instead of or in addition to removing non-zero brain emulation parameters from the compressed matrix representation, the training engine 316 can add “new” non-zero brain emulation parameters to the weight matrix at each of one or more training stages. For example, the training engine 316 can randomly sample one or more zero-value brain emulation parameters of the weight matrix, generate values for the sampled zero-value brain emulation parameters, and insert the sampled zero-value brain emulation parameters, having the respective generated values, into the weight matrix as newly-non-zero brain emulation parameters.

For example, the training engine 316 can sample a respective value for each new non-zero brain emulation parameter from a predefined distribution, e.g., a uniform distribution between 0 and 1 or a Normal distribution with mean 0.

As another example, the training engine 316 can determine the initial value of the new non-zero brain emulation parameters to be 0. Then, during training of the reservoir computing neural network 302, the value of these new non-zero brain emulation parameters can be updated to actually have non-zero values, e.g., using stochastic gradient descent.

In some implementations, the training engine 316 samples the same number of zero-value brain emulation parameters as the number of non-zero value brain emulation parameters sampled as described above. That is, the weight matrix can include the same number of non-zero brain emulation parameters before and after the training stage. In some other implementations, the training engine 316 samples a different number of non-zero and zero-value brain emulation parameters during a given training stage, such that the number of non-zero brain emulation parameters in the weight matrix changes.

In some implementations, the training engine 316 can sample new non-zero brain emulation parameters to add to the weight matrix such that the sampled new non-zero brain emulation parameters are biologically plausible. That is, the training engine 316 can ensure that each new non-zero brain emulation parameter represents a pair of neuronal elements that could plausibly share a biological connection in the brain of the biological organism. For example, the training engine 316 can sample new non-zero brain emulation parameters corresponding to pairs of neuronal elements in the same region of the brain of the biological organism.

After the training system 300 has completed training of the reservoir computing neural network 302, the reservoir computing neural network 302 can be added to an ensemble model that includes multiple different reservoir computing neural networks (or added to a pool of reservoir computing neural networks from which a training system for the ensemble model samples), as described above.

FIG. 3B illustrates an example weight matrix 354 of a brain emulation neural network layer determined using biological connectivity.

As described in more detail below with reference to FIG. 4B, a system (e.g., the graphing system 412 depicted in FIG. 4B), can generate a synaptic connectivity graph that represents the biological connectivity between neuronal elements in the brain of the biological organism. The synaptic connectivity graph can be represented using an adjacency matrix 352, all of which or a portion of which can be used as the weight matrix 354 of the brain emulation neural network layer.

As illustrated in FIG. 3B, the adjacency matrix 352 includes n² elements, where n is the number of neuronal elements drawn from the brain of the biological organism. For example, the adjacency matrix 352 can include hundreds, thousands, tens of thousands, hundreds of thousands, millions, tens of millions, or hundreds of millions of elements.

Each element of the adjacency matrix 352 represents the biological connectivity between a respective pair of neuronal elements in the set of n neuronal elements. That is, each element ci identifies the biological connection between neuronal element i and neuronal element j. As described in more detail below, in some implementations, each of the elements c_{i,j} are either zero (representing that there is no biological connection between the corresponding neuronal elements) or one (representing that there is a biological connection between the corresponding neuronal elements), while in some other implementations, each element ci is a scalar value representing the strength of the biological connection between the corresponding neuronal elements.

Each row and each column of the adjacency matrix 352 can represent a respective neuronal element in the brain of the biological organism. In particular, each row of the adjacency matrix 402 can represent a respective neuronal element in a first set of neuronal elements of the brain of the biological organism, and each column of the adjacency matrix 402 can represent a respective neuronal element in a second set of neuronal elements of the brain of the biological organism. Generally, the first set and the second set can be overlapping or disjoint. As a particular example, the first set and the second set can be the same.

In some implementations (e.g., in implementations in which the synaptic connectivity graph is undirected), the adjacency matrix 352 is symmetric (i.e., each element c_{i,j} is the same as element c_{j,i}), while in some other implementations (e.g., in implementations in which the synaptic connectivity graph is directed), the adjacency matrix 352 is not symmetric (i.e., there may exist elements c_{i,j} and c_{j,i} such that c_{i,j}≠c_{j,i}).

Although the above description refers to neuronal elements in the brain of the biological organism, generally the elements of the adjacency matrix can correspond to pairs of any appropriate component of the brain of the biological organism. For example, each element can correspond to a pair of voxels in a voxel grid of the brain of the biological organism.

As described in more detail below with reference to FIG. 4B, an architecture mapping system (e.g., the architecture mapping system 420 depicted in FIG. 4B) can generate the weight matrix 354 from the adjacency matrix 352. Generally, the elements of the weight matrix 354 (i.e., the brain emulation parameters of the brain emulation neural network layer) are a subset of the elements of the adjacency matrix 352. For example, as depicted in FIG. 3B, the weight matrix 354 includes the elements of the adjacency matrix 352 representing biological connections between the neuronal elements represented by the first three rows and first three columns of the adjacency matrix 352. For example, the weight matrix 354 can represent only neuronal elements of a particular type in the brain of the biological organism. Identifying neuronal elements of a particular type is discussed in more detail below with reference to FIG. 6A.

For convenience, the weight matrix 354 is illustrated as including only nine brain emulation parameters; generally, weight matrices of brain emulation neural network layers can have significantly more brain emulation parameters, e.g., hundreds, thousands, or millions of brain emulation parameters. Although the weight matrix 354 is depicted as square in FIG. 3B (i.e., the same number of columns and rows), generally the weight matrix 354 can have any appropriate dimensionality.

That is, generally the weight matrix 354 can be an M×N matrix, where each of the M rows corresponds to a neuronal element in a first set of neuronal elements and each of the N columns corresponds to a neuronal element in a second set of neuronal elements in the brain of the biological organism. The first set of neuronal elements and the second set of neuronal elements can be overlapping (i.e., one or more neuronal elements in the brain of the biological organism is in both sets) or disjoint (i.e., there does not exist a neuronal element in the brain of the biological organism that is in both sets). As a particular example, the first set and the second set can be the same. That is, the weight matrix 354 can be an N×N matrix where the same neuronal elements in the brain of the biological organism are represented by both the rows and the columns of the weight matrix. The process of generating the weight matrix is described in more detail below.

In some implementations, the weight matrix 354 represents the entire synaptic connectivity graph. That is, the weight matrix 354 can include a respective row and column for each node of the synaptic connectivity graph. The weight matrix 404 can be a sparse matrix, i.e., can include more than a threshold number or proportion of zero-value brain emulation parameters.

FIG. 4A illustrates an example of generating an artificial (i.e., computer implemented) brain emulation reservoir computing neural network 409 based on a synaptic resolution image 405 of the brain 403 of a biological organism 401, e.g., a fly.

The synaptic resolution image 405 can be processed to generate a synaptic connectivity graph 607. The synaptic connectivity graph 607 represents synaptic connectivity between neuronal elements in the brain 603 of the biological organism 601. A “neuronal element” can refer to an individual neuron, a portion of a neuron, a group of neurons, or any other appropriate biological element in the brain 603 of the biological organism 601. The synaptic connectivity graph 607 can include multiple nodes and multiple edges, where each edge connects a respective pair of nodes. At least a subset of the nodes of the synaptic connectivity graph 607 can represent respective neuronal elements in the brain 603 of the biological organism, and each edge between pairs of nodes in the subset can represent a biological connection between the pair of neuronal elements corresponding to the pair of nodes. In one example, each node in the graph 108 can represent an individual neuron, and each edge connecting a pair of nodes in the graph 108 can represent a respective synaptic connection between the corresponding pair of individual neurons.

In some implementations, the synaptic connectivity graph 607 can be an “over-segmented” synaptic connectivity graph, e.g., where at least some nodes in the graph represent a portion of a neuron, and at least some edges in the graph connect pairs of nodes that represent respective portions of neurons. In some implementations, the synaptic connectivity graph 607 can be a “contracted” synaptic connectivity graph, e.g., where at least some nodes in the graph represent a group of neurons, and at least some edges in the graph represent respective connections (e.g., nerve fibers) between such groups of neurons. In some implementations, the synaptic connectivity graph 607 can include features of both the “over-segmented” graph and the “contracted” graph. Generally, the synaptic connectivity graph 607 can include nodes and edges that represent any appropriate neuronal element, and any appropriate biological connection between a pair of neuronal elements, respectively, in the brain 603 of the biological organism 601.

The structure of the synaptic connectivity graph 407 can be used to specify the architecture of the brain emulation reservoir computing neural network 409. For example, each node of the graph 407 can be mapped to an artificial neuron, a neural network layer, or a group of neural network layers in the brain emulation reservoir computing neural network 409. Further, each edge of the graph 407 can be mapped to a connection between artificial neurons, layers, or groups of layers in the brain emulation reservoir computing neural network 409. The brain 403 of the biological organism 401 can be adapted by evolutionary pressures to be effective at solving certain tasks, e.g., classifying objects or generating robust object representations, and the brain emulation reservoir computing neural network 409 can share this capacity to effectively solve tasks.

In some implementations, an optimization system 422 can process the graph 407 and partition the graph 407 into multiple community sub-graphs. Based on the community sub-graphs, the system 422 can select the neural network architecture 409 for performing the machine learning task.

Generally, the brain 403 of the biological organism 401 can include ensembles (groups) of biological neuronal elements that have a substantially large number of biological connections (e.g., synapses, or nerve tracts) between neuronal elements within the ensemble, relative to the number of biological connections between neuronal elements in different ensembles. In other words, neuronal elements within the ensemble can be more densely connected (e.g., clustered) when compared to neuronal elements in different ensembles. Such ensembles can be referred to as “communities” of biological neuronal elements. Some communities of biological neuronal elements in the brain 403 can be functionally-specialized, e.g., can perform a particular function such as processing of visual data, processing of audio data, or any other appropriate function.

For example, biological neuronal elements within the visual cortex region of the brain 403 can be densely connected to facilitate efficient processing of visual information, while biological neuronal elements within the auditory data processing region of the brain 403 can be densely connected to facilitate efficient processing of auditory information. However, connections between neuronal elements that are positioned in the visual cortex and neuronal elements that are positioned in the audio cortex can be relatively sparse. Accordingly, biological neuronal elements within each of these regions of the brain 403 can each belong to a different functionally-specialized community.

However, the above example is provided for illustrative purposes only, and each community of biological neuronal elements in the brain 403 may not necessarily be functionally-specialized, and some communities of biological neuronal elements can perform the same, or similar, function, as some of the other communities of biological neuronal elements in the brain 403.

The optimization system 422 can process the synaptic connectivity graph 407 and determine a partition of the graph 407 into multiple community sub-graphs. Generally, a “sub-graph” of the synaptic connectivity graph 407 can refer to a graph specified by: (i) a proper subset of the nodes of the synaptic connectivity graph 407, and (ii) a proper subset of the edges of the synaptic connectivity graph 407. A “community sub-graph” of the synaptic connectivity graph 407 can refer to a sub-graph that represents biological neuronal elements that belong to a community in the brain 403 of the biological organism 401.

The optimization system 422 can partition the synaptic connectivity graph 407 into multiple community sub-graphs by performing an optimization that encourages a higher measure of connectedness between nodes included within each community sub-graph, relative to nodes included in different community sub-graphs. By partitioning the synaptic connectivity graph 407 in this manner, the optimization can therefore encourage the identification of individual communities of biological neuronal elements in the brain, where each community is represented by a respective community sub-graph of the synaptic connectivity graph 407.

In some implementations, for each community sub-graph, the optimization system 422 can determine a set of features that predict a biological function of the corresponding community of biological neuronal elements in the brain 403 of the biological organism 401. For example, an architecture mapping system can process each community sub-graph and determine types of neuronal elements that are represented by the nodes included in each of the community sub-graphs. Based on the predicted neuronal element types, the architecture mapping system can associate each community sub-graph with one or more corresponding functions in the brain 403 of the biological organism 401.

The optimization system 422 can select the neural network architecture 409 for performing the machine learning task based on community sub-graphs. For example, the optimization system 422 can instantiate multiple candidate neural network architectures, each architecture including one or more brain emulation sub-networks that each have a respective architecture specified by a respective community sub-graph. The optimization system 422 can evaluate a performance of each candidate neural network architecture at the machine learning task.

By way of example, the optimization system 422 can process the synaptic connectivity graph 407 and identify a community sub-graph that represents a community of biological neuronal elements in the visual cortex, and a community sub-graph that represents a community of biological neuronal elements in the auditory cortex. The system 422 can instantiate candidate neural network architectures based on each of these community sub-graphs, and evaluate their performance at the machine learning task, e.g., a visual processing task. Because different regions of the brain 403 of the biological organism 401 may be adapted by evolutionary pressures to be effective at solving certain tasks, or performing certain functions, the candidate neural network architectures, based on the respective community sub-graphs that represent different regions of the brain 403, may inherit the capacity of the respective regions of the brain to effectively solve tasks.

Accordingly, in this example, the system 422 can determine, e.g., that the candidate neural network architecture that is specified by the community sub-graph that represents biological neuronal elements in the visual cortex region of the brain 403 is more effective at performing the visual processing task, than the candidate neural network architecture that is specified by the community sub-graph that represents the auditory cortex region of the brain 403. The system 422 can select, e.g., the most effective candidate neural network architecture 409 for performing the machine learning task, e.g., the visual processing task in this example.

After selecting the neural network architecture 409, the system 422 can instantiate a neural network having the neural network architecture 409 and use it to perform the machine learning task. However, the above example is provided for illustrative purposes only, and in some cases the system 422 may not necessarily select the best-performing candidate neural network architecture. Further, the system 422 can select any number of neural network architectures 409 for performing any appropriate number and type of machine learning tasks.

Determining community sub-graphs of a synaptic connectivity graph described in more detail in U.S. patent application Ser. No. 17/524,574, entitled “Selecting Neural Network Architectures based on Community Graphs,” to Sarah Laszlo and Hailey Trier, filed on Nov. 11, 2021, the entire contents of which are hereby incorporated by reference.

FIG. 4B shows an example data flow 400 for generating a synaptic connectivity graph 402 and a brain emulation reservoir computing neural network 404 based on the brain 406 of a biological organism. As used throughout this document, a brain may refer to any amount of nervous tissue from a nervous system of a biological organism, and nervous tissue may refer to any tissue that includes neurons (i.e., nerve cells). The biological organism can be, e.g., a worm, a fly, a mouse, a cat, or a human.

An imaging system 408 can be used to generate a synaptic resolution image 410 of the brain 406. An image of the brain 406 may be referred to as having synaptic resolution if it has a spatial resolution that is sufficiently high to enable the identification of at least some synapses in the brain 406. Put another way, an image of the brain 406 may be referred to as having synaptic resolution if it depicts the brain 406 at a magnification level that is sufficiently high to enable the identification of at least some synapses in the brain 406. The image 410 can be a volumetric image, i.e., that characterizes a three-dimensional representation of the brain 406. The image 410 can be represented in any appropriate format, e.g., as a three-dimensional array of numerical values.

The imaging system 408 can be any appropriate system capable of generating synaptic resolution images, e.g., an electron microscopy system. The imaging system 408 can process “thin sections” from the brain 406 (i.e., thin slices of the brain attached to slides) to generate output images that each have a field of view corresponding to a proper subset of a thin section. The imaging system 408 can generate a complete image of each thin section by stitching together the images corresponding to different fields of view of the thin section using any appropriate image stitching technique. The imaging system 408 can generate the volumetric image 410 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system 412 is configured to process the synaptic resolution image 410 to generate the synaptic connectivity graph 402. The synaptic connectivity graph 402 specifies a set of nodes and a set of edges, such that each edge connects two nodes. To generate the graph 402, the graphing system 412 identifies each neuronal element (e.g., each neuron, portion of a neuron, or group of neurons) in the image 410 as a respective node in the graph, and identifies each biological connection between a pair of neuronal elements in the image 410 as an edge between the corresponding pair of nodes in the graph.

The graphing system 412 can identify the neuronal elements and the biological connections depicted in the image 410 using any of a variety of techniques. For example, the graphing system 412 can process the image 410 to identify the positions of the neuronal elements depicted in the image 410, and determine whether a biological connection connects two neuronal elements based on the proximity of the neuronal elements (as will be described in more detail below). In this example, the graphing system 412 can process an input including: (i) the image, (ii) features derived from the image, or (iii) both, using a machine learning model that is trained using supervised learning techniques to identify neuronal elements in images. The machine learning model can be, e.g., a convolutional neural network model or a random forest model. The output of the machine learning model can include a neuronal element probability map that specifies a respective probability that each voxel in the image is included in a neuronal element. The graphing system 412 can identify contiguous clusters of voxels in the neuronal element probability map as being neuronal elements.

Optionally, prior to identifying the neuronal elements from the neuronal element probability map, the graphing system 412 can apply one or more filtering operations to the neuronal element probability map, e.g., with a Gaussian filtering kernel. Filtering the neuronal element probability map can reduce the amount of “noise” in the neuronal element probability map, e.g., where only a single voxel in a region is associated with a high likelihood of being a neuronal element.

The machine learning model used by the graphing system 412 to generate the neuronal element probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuronal element. The target outputs of the training examples can be generated by manual annotation, e.g., where a person manually specifies which voxels of a training input are included in neuronal elements.

Example techniques for identifying the positions of neuronal elements depicted in the image 410 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 412 can identify the biological connections connecting the neuronal elements in the image 410 (e.g., the synapses connecting the neurons in the image 410) based on the proximity of the neuronal elements. For example, the graphing system 412 can determine that a first neuronal element is connected by a biological connection to a second neuronal element based on the area of overlap between: (i) a tolerance region in the image around the first neuronal element, and (ii) a tolerance region in the image around the second neuronal element. That is, the graphing system 412 can determine whether the first neuronal element and the second neuronal element are connected based on the number of spatial locations (e.g., voxels) that are included in both: (i) the tolerance region around the first neuronal element, and (ii) the tolerance region around the second neuronal element. For example, the graphing system 412 can determine that two neuronal elements are connected if the overlap between the tolerance regions around the respective neuronal elements includes at least a predefined number of spatial locations (e.g., one spatial location). A “tolerance region” around a neuronal element refers to a contiguous region of the image that includes the neuronal element. For example, the tolerance region around a neuronal element can be specified as the set of spatial locations in the image that are either: (i) in the interior of the neuronal element, or (ii) within a predefined distance of the interior of the neuronal element.

The graphing system 412 can further identify a weight value associated with each edge in the graph 402. For example, the graphing system 412 can identify a weight for an edge connecting two nodes in the graph 402 based on the area of overlap between the tolerance regions around the respective neuronal elements corresponding to the nodes in the image 410. The area of overlap can be measured, e.g., as the number of voxels in the image 410 that are contained in the overlap of the respective tolerance regions around the neuronal elements. The weight for an edge connecting two nodes in the graph 402 may be understood as characterizing the (approximate) strength of the connection between the corresponding neuronal elements in the brain (e.g., the amount of information flow through the synapse connecting the two neurons).

In addition to identifying biological connections in the image 410, the graphing system 412 can further determine the direction of each biological connection using any appropriate technique. The “direction” of a biological connection between two neuronal elements refers to the direction of information flow between the two neuronal elements, e.g., if a first neuronal element uses a biological connection to transmit signals to a second neuronal element, then the direction of the biological connection would point from the first neuronal element to the second neuronal element. Example techniques for determining the directions of biological connections connecting pairs of neuronal elements are described with reference to: C. Seguin, A. Razi, and A. Zalesky: “Inferring neural signaling directionality from undirected structure connectomes,” Nature Communications 10, 4289 (2019), doi:10.1038/s41467-019-12201-w.

In implementations where the graphing system 412 determines the directions of the biological connections in the image 410, the graphing system 412 can associate each edge in the graph 402 with the direction of the corresponding biological connection. That is, the graph 402 can be a directed graph. In some other implementations, the graph 402 can be an undirected graph, i.e., where the edges in the graph are not associated with a direction.

The graph 402 can be represented in any of a variety of ways. For example, the graph 402 can be represented as a two-dimensional array of numerical values with a number of rows and columns equal to the number of nodes in the graph. The component of the array at position (i,j) can have value 1 if the graph includes an edge pointing from node i to node j, and value 0 otherwise. In implementations where the graphing system 412 determines a weight value for each edge in the graph 402, the weight values can be similarly represented as a two-dimensional array of numerical values. More specifically, if the graph includes an edge connecting node i to node j, the component of the array at position (i,j) can have a value given by the corresponding edge weight, and otherwise the component of the array at position (i,j) can have value 0.

An architecture mapping system 420 can process the synaptic connectivity graph 402 to determine the architecture of the brain emulation reservoir computing neural network 404 (or a brain emulation reservoir subnetwork of a neural network). For example, the architecture mapping system 420 can map each node in the graph 402 to: (i) an artificial neuron, (ii) a neural network layer, or (iii) a group of neural network layers, in the architecture of the brain emulation reservoir computing neural network 404. The architecture mapping system 420 can further map each edge of the graph 402 to a connection in the brain emulation reservoir computing neural network 404, e.g., such that a first artificial neuron that is connected to a second artificial neuron is configured to provide its output to the second artificial neuron. In some implementations, the architecture mapping system 420 can apply one or more transformation operations to the graph 402 before mapping the nodes and edges of the graph 402 to corresponding components in the architecture of the brain emulation reservoir computing neural network 404, as will be described in more detail below. An example architecture mapping system is described in more detail below with reference to FIG. 6A.

In some implementations, the architecture mapping system 404 is an optimization system that is configured to perform an optimization to determine one or more community sub-graphs from the synaptic connectivity graph. The optimization system can then generate the brain emulation reservoir computing neural network from one or more of the determined community sub-graphs. Community sub-graphs are discussed in more detail above with reference to FIG. 4A and in U.S. patent application Ser. No. 17/524,574, which has been incorporated by reference.

The brain emulation reservoir computing neural network 404 can be provided to a training system 414 that trains the brain emulation reservoir computing neural network using machine learning techniques, i.e., generates an update to the respective values of one or more brain emulation parameters of the brain emulation reservoir computing neural network.

The training system 414 can be a component of a training system for an ensemble model that includes multiple reservoir computing neural networks, e.g., multiple different brain emulation reservoir computing neural networks. For example, the training system 414 can be the reservoir computing neural network training system 300 described above with reference to FIG. 3A.

After the training system 414 has completed training of the brain emulation reservoir computing neural network 404, the brain emulation reservoir computing neural network 404 can be added to an ensemble model that includes multiple different reservoir computing neural networks (or added to a pool of reservoir computing neural networks from which a training system for the ensemble model samples), as described above.

FIG. 5 illustrates an example block 500 of neural network layers that includes example connectivity neural network layers 510 and 540 and an example brain emulation reservoir subnetwork 530. The block 500 of neural network layers is a component of a brain emulation reservoir computing neural network.

As described above, the connectivity neural network layers 510 and 540 immediately precede and follow, respectively, the brain emulation reservoir subnetwork 530 in the network architecture of the brain emulation reservoir computing neural network. Generally, the brain emulation reservoir subnetwork 530 can be at any appropriate location in the network architecture of the brain emulation reservoir neural network.

The block 500 of neural network layers is configured to receive as input an encoded network input 502, which has been generated by one or more non-biological neural network layers preceding the block 500 in the network architecture of the brain emulation reservoir computing neural network by processing the network input to the brain emulation reservoir computing neural network. In some implementations, the encoded network input 502 is the same as the network input; that is, the input connectivity neural network layer 510 can be the first neural network layer in the brain emulation reservoir computing neural network and the block 500 of neural network layers can be configured to process the network input directly.

Before processing the encoded network input 502 using the input connectivity neural network layer 510, the brain emulation reservoir computing neural network divides the encoded network input 502 into N different input channels 504a-n, N>1. Although the encoded network input 502 is depicted as three-dimensional in FIG. 5, generally the input to the block 500 can have any dimensionality. For example, each element of the encoded network input 502 can be included in exactly one input channel 504a-n. As another example, the input channels 504a-n can partially overlap, i.e., such that one or more elements of the encoded network input 502 are included in multiple respective input channels 504a-n.

In some implementations, each input channel 504a-n has a lower dimensionality than the encoded network input 502. For example, each input channel 504a-n can correspond to a respective different index along a particular dimension of the encoded network input 502, and includes every element of the encoded network input 502 having the respective index in the particular dimension. As a particular example, if the encoded network input 502 has size L₁×W₁, then the brain emulation reservoir computing neural network can divide the encoded network input into L₁ input channels 504a-n (i.e., N=L₁), where each input channel has size W₁. As another particular example, if the encoded network input 502 has size L₁×W₁×H₁, then the brain emulation reservoir computing neural network can divide the encoded network input into H₁ input channels 504a-n (i.e., N=H₁), where each input channel 504a-n has size L₁×W₁.

In some other implementations, each input channel 504a-n has the same dimensionality as the encoded network input 502. For example, if the encoded network input 502 is two-dimensional having size 100×100, then the brain emulation reservoir computing neural network can divide the encoded network input into 100 input channels 504a-n each having size 10×10. As another example, if the encoded network input 502 is three-dimensional having size 100×100×100, then the brain emulation reservoir computing neural network can divide the encoded network input into 1000 input channels 504a-n each having size 10 ×10×10.

Before training the brain emulation reservoir computing neural network, a training system can randomly assign each position of the encoded network input 502 to one or more respective input channels 504a-n. Then, each time the brain emulation reservoir computing neural network is executed, the brain emulation reservoir computing neural network can assign the element at each position to the one or more input channels 504a-n corresponding to the position. That is, in some implementations, each element in the encoded network input 502 is included in exactly one input channel 504a-n, while in some other implementations, some or all of the elements in the encoded network input 502 are included in more than one input channel 504a-n.

For example, the input channels 504a-n can “overlap” each other within the encoded network input 502. As a particular example, if the encoded network input 502 is a one-dimensional input having ten elements, then the encoded network input 502 can be divided into four input channels 504a-n each having four elements, where elements 1-4 are assigned to the first input channel, elements 3-6 are assigned to the second input channel, elements 5-8 are assigned to the third input channel, and elements 7-10 are assigned to the fourth input channel.

In some implementations, each of the input channel 504a-n has the same size. In some other implementations, different input channels 504a-n can have different sizes.

The input connectivity neural network layer 510 includes M different sub-layers 520a-n that are each configured to process a respective proper subset of the input channels 504a-n and to generate a respective updated channel 512a-m. That is, each input connectivity sub-layer 520a-m includes a subset of the parameters of the input connectivity layer 510, and uses the subset of the parameters to process the respective proper subset of input channels 504a-n to generate the respective updated channel 512a-m.

In some implementations, each of the updated channel 512a-m has the same size. In some other implementations, different input channels 512a-m can have different sizes. Thus, the input connectivity neural network layer 510 is configured to process N input channels 504a-n and generate M updated channels 512a-m. In some implementations, M=N. For example, each input connectivity sub-layer 520a-m can be configured to process exactly one input channel 504a-n to generate the corresponding updated channel 512a-m, where each input channel 504a-n is processed by exactly one input connectivity sub-layer 520a-m. In some other implementations, M>N, such that at least one input channel 504a-n is processed by multiple different input connectivity sub-layers 520a-m. In some other implementations, N>M, such that at least one input connectivity sub-layer 520a-m is configured to process multiple different input channels 504a-n.

In some implementations, each input connectivity sub-layer is configured to process the same number of input channels 504a-n. In some other implementations, different input connectivity sub-layers can be configured to process a different number of input channels 504a-n. For example, the first input connectivity sub0layer 520a is configured to process one input channel 504a, while the M^{th} input connectivity sub-layer 520m is configured to process two input channels 504a and 504n.

In some implementations, each input channel 504a-n is processed by the same number of input connectivity sub-layers 520a-m. In some other implementations, different input channels 504a-n are processed by a different number of input connectivity sub-layers 520a-m. For example, the first input channel 504a is processed by one input connectivity sub-layer 520a, while the N^{th} input channel 504n is processed by two input connectivity sub-layers 520a and 520m.

In some implementations, for each input connectivity sub-layer 520a-m, the size of the updated channel 512a-m generated by the sub-layer is the same as the size of the input channels 504a-n processed by the sub-layer. In some other implementations (e.g., as depicted in FIG. 5), the size of the updated channel 512a-m generated by the sub-layer has a different size than the input channels 504a-n processed by the sub-layer. For example, the updated channel 512a-m generated by the sub-layer can have the same dimensionality as the input channels 504a-n processed by the sub-layer while having more or fewer parameters. As another example, the updated channel 512a-m generated by the sub-layer can have a different dimensionality than the input channels 504a-n processed by the sub-layer.

Each input connectivity sub-layer 520a-n can use any appropriate architecture to generate the respective updated channel 512a-m.

For example, each input connectivity sub-layer 520a-m can be a fully-connected neural network layer. In this example, dividing the encoded network input 502 into the input channels 504a-n can still improve the efficiency of the connectivity neural network layer 510 compared to processed the full encoded network input 502 using a fully-connected neural network layer. As an illustrative example, if N=M, and if each input channel 504a-n has size L₁×W₁ and each updated channel has size L₂×W₂, then the number of parameters of the input connectivity neural network layer 510 is N·(L₁·W₁)·(L₂·W₂). If the input connectivity neural network layer 510 were a fully-connected neural network layer, then the number of parameters would be (L₁·W₁·N)·(L₂·W₂·N). Thus, dividing the encoded network input 502 into the input channels 504a-n improves the efficiency of the input connectivity neural network layer 510 by a factor of N.

As another example, each updated channel 512a-m can be a linear combination of the corresponding input channels 504a-n. That is, each input connectivity sub-layer 520a-m can generate its respective updated channel 512a-m by determining a weighted sum of its respective input channels 504a-n. As an illustrative example, if each sub-layer 520a-m processes k input channels 504a-n, then the input connectivity neural network layer 510 only has k·M learned parameters, a significant efficiency improvement over the case, described above, where the input connectivity neural network layer 510 is a fully-connected layer.

As another example, each input connectivity sub-layer can process the corresponding proper subset of input channels 504a-n using a convolutional kernel.

The brain emulation reservoir subnetwork 530 is configured to process the updated channels 512a-m and to generate P brain emulation channels 532a-p, P>1. As described above, the parameters of the brain emulation reservoir subnetwork 530 can be determined using biological connectivity between neuronal elements in the brain of a biological organism. In some implementations, P=M. In some other implementations, P>M. In some other implementations, P<M.

In some implementations, each of the brain emulation channels 532a-p has the same size. In some other implementations, different brain emulation channels 532a-p can have different sizes.

In some implementations, the brain emulation reservoir subnetwork 530 does not process the updated channels 512a-m independently. Rather, the brain emulation reservoir subnetwork 530 can combine the updated channels 512a-m into a single brain emulation reservoir subnetwork input, and process the brain emulation reservoir subnetwork input to generate the brain emulation channels 532a-p.

In some implementations, the output of the brain emulation reservoir subnetwork 530 is not explicitly divided into the P brain emulation channels 532a-p. That is, the brain emulation reservoir subnetwork 530 can be configured to generate a single brain emulation output, and the brain emulation reservoir computing neural network can then divide the brain emulation output into the brain emulation channels 532a-p. For example, the brain emulation reservoir computing neural network can divide the brain emulation output in any way described above with reference to dividing the encoded network input 502.

In some implementations, the architecture of the brain emulation reservoir subnetwork 530 is represented using a weight matrix, where each element of the weight matrix is a respective parameter of the brain emulation reservoir subnetwork 530. Each element of the weight matrix can correspond to a pair of neuronal elements in the brain of the biological organism, where the value of the element characterizes a strength of a biological connection between the pair of neuronal elements. In other words, each row and column of the weight matrix can correspond to a respective neuronal element in the brain of the biological organism, and the value of each element characterizes a strength of a biological connection between (i) the neuronal element corresponding to the row of the element and (ii) the neuronal element corresponding to the column of the element. The process of generating the weight matrix is described in more detail below.

For example, the weight matrix of the brain emulation reservoir subnetwork 530 can have size M×P, such that the size of the brain emulation channels 532a-p is the same as the size of the updated channels 512a-m. In other words, each brain emulation channel 532a-p can be a linear combination of the updated channels 512a-m, where the linear combination corresponding to brain emulation channel 532i is defined by the i^{th} column of the weight matrix.

As another example, the brain emulation reservoir subnetwork 530 can be a fully-connected neural network layer. As an illustrative example, if the updated channels 512a-m have size L₂×W₂ and the brain emulation channels 532a-p have size L₃×W₃, then the weight matrix of the brain emulation reservoir subnetwork 530 has size (M·L₂·W₂)×(P·L₃·W₃).

In some implementations, the weight matrix is a square matrix where the same neuronal elements in the brain of the biological organism are represented by both the rows and the columns of the weight matrix.

The output connectivity neural network layer 540 is configured to process the brain emulation channels 532a-p to generate Q output channels 552a-q, Q>1. The output connectivity neural network layer 540 can be configured similarly to the input connectivity layer 510. The output connectivity neural network layer 540 can have any of the configurations described above with reference to the input connectivity layer 510. In particular, the output connectivity neural network layer 540 can include Q output connectivity sub-layers 550a-q that are each configured to process a respective proper subset of the brain emulation channels 532a-p to generate a respective output channel 552a-q.

In some implementations, the brain emulation reservoir computing neural network can process the output channels 552a-q using one or more subsequent non-biological neural network layers of the brain emulation reservoir computing neural network to generate a network output for the brain emulation reservoir computing neural network. In some other implementations, the output connectivity neural network layer 540 is the final neural network layer in the brain emulation reservoir computing neural network, and the brain emulation reservoir computing neural network combines the output channels 552a-q to generate the network output.

FIG. 6A shows an example architecture mapping system 600. The architecture mapping system 600 is an example of a system implemented as computer programs on one or more computers in one or more locations in which the systems, components, and techniques described below are implemented.

The architecture mapping system 600 is configured to process a synaptic connectivity graph 601 (e.g., the synaptic connectivity graph 402 described above with reference to FIG. 4B) to determine a corresponding neural network architecture 602 of a brain emulation reservoir computing neural network 616 (e.g., the brain emulation reservoir computing neural network 404 depicted in FIG. 4B). Although the below description generally refers to implementations in which the architecture mapping system 600 processes the entire synaptic connectivity graph 601, generally the same techniques can be applied to process a sub-graph of the synaptic connectivity graph 601, e.g., a community sub-graph of the synaptic connectivity graph 601.

The architecture mapping system 600 can determine the architecture 602 using one or more of: a transformation engine 604, a feature generation engine 606, a node classification engine 608, and a nucleus classification engine 618, which will each be described in more detail next.

After determine the neural network architecture 602 of the brain emulation reservoir computing neural network 616, the architecture mapping system 600 can provide the brain emulation reservoir computing neural network 616 to a training system for training, e.g., the training engine 220 described above with reference to FIG. 2A or the training system 300 described above with reference to FIG. 3. The trained brain emulation reservoir computing neural network 616 can be added to an ensemble model that includes multiple different reservoir computing neural networks (or added to a pool of reservoir computing neural networks from which a training system for the ensemble model samples), as described above.

The transformation engine 604 can be configured to apply one or more transformation operations to the synaptic connectivity graph 601 that alter the connectivity of the graph 601, i.e., by adding or removing edges from the graph. A few examples of transformation operations follow.

In one example, to apply a transformation operation to the graph 601, the transformation engine 604 can randomly sample a set of node pairs from the graph (i.e., where each node pair specifies a first node and a second node). For example, the transformation engine can sample a predefined number of node pairs in accordance with a uniform probability distribution over the set of possible node pairs. For each sampled node pair, the transformation engine 604 can modify the connectivity between the two nodes in the node pair with a predefined probability (e.g., 0.1%). In one example, the transformation engine 604 can connect the nodes by an edge (i.e., if they are not already connected by an edge) with the predefined probability. In another example, the transformation engine 604 can reverse the direction of any edge connecting the two nodes with the predefined probability. In another example, the transformation engine 604 can invert the connectivity between the two nodes with the predefined probability, i.e., by adding an edge between the nodes if they are not already connected, and by removing the edge between the nodes if they are already connected.

In another example, the transformation engine 604 can apply a convolutional filter to a representation of the graph 601 as a two-dimensional array of numerical values. As described above, the graph 601 can be represented as a two-dimensional array of numerical values where the component of the array at position (i,j) can have value 1 if the graph includes an edge pointing from node i to node j, and value 0 otherwise. The convolutional filter can have any appropriate kernel, e.g., a spherical kernel or a Gaussian kernel. After applying the convolutional filter, the transformation engine 604 can quantize the values in the array representing the graph, e.g., by rounding each value in the array to 0 or 1, to cause the array to unambiguously specify the connectivity of the graph. Applying a convolutional filter to the representation of the graph 601 can have the effect of regularizing the graph, e.g., by smoothing the values in the array representing the graph to reduce the likelihood of a component in the array having a different value than many of its neighbors.

In some cases, the graph 601 can include some inaccuracies in representing the biological connectivity in the biological brain. For example, the graph can include nodes that are not connected by an edge despite the corresponding neurons in the brain being connected by a synapse, or “spurious” edges that connect nodes in the graph despite the corresponding neurons in the brain not being connected by a synapse. Inaccuracies in the graph can result, e.g., from imaging artifacts or ambiguities in the synaptic resolution image of the brain that is processed to generate the graph. Regularizing the graph, e.g., by applying a convolutional filter to the representation of the graph, can increase the accuracy with which the graph represents the biological connectivity in the brain, e.g., by removing spurious edges.

The architecture mapping system 600 can use the feature generation engine 606 and the node classification engine 608 to determine predicted “types” 610 of the neuronal elements corresponding to the nodes in the graph 601. The type of a neuronal element can characterize any appropriate aspect of the neuronal element. In one example, the type of a neuronal element can characterize the function performed by the neuronal element in the brain, e.g., a visual function by processing visual data, an olfactory function by processing odor data, or a memory function by retaining information.

After identifying the types of the neuronal elements corresponding to the nodes in the graph 601, the architecture mapping system 600 can identify a sub-graph 612 of the overall graph 601 based on the neuronal element types, and determine the neural network architecture 602 based on the sub-graph 612. The feature generation engine 606 and the node classification engine 608 are described in more detail next.

The feature generation engine 606 can be configured to process the graph 601 (potentially after it has been modified by the transformation engine 604) to generate one or more respective node features 614 corresponding to each node of the graph 601. The node features corresponding to a node can characterize the topology (i.e., connectivity) of the graph relative to the node. In one example, the feature generation engine 606 can generate a node degree feature for each node in the graph 601, where the node degree feature for a given node specifies the number of other nodes that are connected to the given node by an edge. In another example, the feature generation engine 606 can generate a path length feature for each node in the graph 601, where the path length feature for a node specifies the length of the longest path in the graph starting from the node. A path in the graph may refer to a sequence of nodes in the graph, such that each node in the path is connected by an edge to the next node in the path. The length of a path in the graph may refer to the number of nodes in the path. In another example, the feature generation engine 606 can generate a neighborhood size feature for each node in the graph 601, where the neighborhood size feature for a given node specifies the number of other nodes that are connected to the node by a path of length at most N. In this example, N can be a positive integer value. In another example, the feature generation engine 606 can generate an information flow feature for each node in the graph 601. The information flow feature for a given node can specify the fraction of the edges connected to the given node that are outgoing edges, i.e., the fraction of edges connected to the given node that point from the given node to a different node.

In some implementations, the feature generation engine 606 can generate one or more node features that do not directly characterize the topology of the graph relative to the nodes. In one example, the feature generation engine 606 can generate a spatial position feature for each node in the graph 601, where the spatial position feature for a given node specifies the spatial position in the brain of the neuronal element corresponding to the node, e.g., in a Cartesian coordinate system of the synaptic resolution image of the brain. In another example, the feature generation engine 606 can generate a feature for each node in the graph 601 indicating whether the corresponding neuronal element is excitatory or inhibitory. In another example, the feature generation engine 606 can generate a feature for each node in the graph 601 that identifies the neuropil region associated with the neuronal element corresponding to the node.

In some cases, the feature generation engine 606 can use weights associated with the edges in the graph in determining the node features 614. As described above, a weight value for an edge connecting two nodes can be determined, e.g., based on the area of any overlap between tolerance regions around the neuronal elements corresponding to the nodes. In one example, the feature generation engine 606 can determine the node degree feature for a given node as a sum of the weights corresponding to the edges that connect the given node to other nodes in the graph. In another example, the feature generation engine 606 can determine the path length feature for a given node as a sum of the edge weights along the longest path in the graph starting from the node.

The node classification engine 608 can be configured to process the node features 614 to identify a predicted neuronal element type 610 corresponding to certain nodes of the graph 601. In one example, the node classification engine 608 can process the node features 614 to identify a proper subset of the nodes in the graph 601 with the highest values of the path length feature. For example, the node classification engine 608 can identify the nodes with a path length feature value greater than the 90th percentile (or any other appropriate percentile) of the path length feature values of all the nodes in the graph. The node classification engine 608 can then associate the identified nodes having the highest values of the path length feature with the predicted neuronal element type of “primary sensory neuronal element.” In another example, the node classification engine 608 can process the node features 614 to identify a proper subset of the nodes in the graph 601 with the highest values of the information flow feature, i.e., indicating that many of the edges connected to the node are outgoing edges. The node classification engine 608 can then associate the identified nodes having the highest values of the information flow feature with the predicted neuronal element type of “sensory neuronal element.” In another example, the node classification engine 608 can process the node features 614 to identify a proper subset of the nodes in the graph 601 with the lowest values of the information flow feature, i.e., indicating that many of the edges connected to the node are incoming edges (i.e., edges that point towards the node). The node classification engine 608 can then associate the identified nodes having the lowest values of the information flow feature with the predicted neuronal element type of “associative neuronal element.”

The architecture mapping system 600 can generate the neural network architecture 602 using the determined neuronal element types 610 corresponding to the nodes of the input graph 601, e.g., corresponding to the synaptic connectivity graph 601 (in implementations in which the entire synaptic connectivity graph 601 is processed by the system 600) or a community sub-graph of the synaptic connectivity graph 601 (in implementations in which only the community sub-graph is processed by the system 600). As a particular example, the architecture mapping system can processed multiple different community sub-graphs of the synaptic connectivity graph 601 to determine the neuronal element types 610 corresponding to the nodes of the respective community sub-graphs, and then select one or more particular community sub-graphs from which to generate the neural network architecture 602 according to the neuronal element types 610. Selecting community sub-graphs according to neuronal element types is discussed in more detail in U.S. patent application Ser. No. 17/524,574, which has been incorporated by reference.

In some implementations, the architecture mapping system 600 identifies one or more sub-graphs 612 of the input graph 601 (e.g., of the entire synaptic connectivity graph 601) based on the predicted neuronal element types 610 corresponding to the nodes of the graph 601. FIG. 6B provides an illustration of an example sub-graph of an overall graph. In one example, the architecture mapping system 600 can select: (i) each node in the graph 601 corresponding to particular neuronal element type, and (ii) each edge in the graph 601 that connects nodes in the graph corresponding to the particular neuronal element type, for inclusion in the sub-graph 612.

The neuronal element type selected for inclusion in the sub-graph can be, e.g., visual neuronal elements, olfactory neuronal elements, memory neuronal elements, or any other appropriate type of neuronal element. In some cases, the architecture mapping system 600 can select multiple neuronal element types for inclusion in the sub-graph 612, e.g., both visual neuronal elements and olfactory neuronal elements.

The type of neuronal element selected for inclusion in the sub-graph 612 can be determined based on the task which the brain emulation reservoir computing neural network 616 will be configured to perform. In one example, the brain emulation reservoir computing neural network 616 can be configured to perform an image processing task, and neuronal elements that are predicted to perform visual functions (i.e., by processing visual data) can be selected for inclusion in the sub-graph 612. In another example, the brain emulation reservoir computing neural network 616 can be configured to perform an odor processing task, and neuronal elements that are predicted to perform odor processing functions (i.e., by processing odor data) can be selected for inclusion in the sub-graph 612. In another example, the brain emulation reservoir computing neural network 616 can be configured to perform an audio processing task, and neuronal elements that are predicted to perform audio processing (i.e., by processing audio data) can be selected for inclusion in the sub-graph 612.

If the edges of the graph 601 are associated with weight values (as described above), then each edge of the sub-graph 612 can be associated with the weight value of the corresponding edge in the graph 601. The sub-graph 612 can be represented, e.g., as a two-dimensional array of numerical values, as described with reference to the graph 601.

Determining the architecture 602 of the brain emulation reservoir computing neural network 616 based on the sub-graph 612 rather than the overall graph 601 can result in the architecture 602 having a reduced complexity, e.g., because the sub-graph 612 has fewer nodes, fewer edges, or both than the graph 601. Reducing the complexity of the architecture 602 can reduce consumption of computational resources (e.g., memory and computing power) by the brain emulation reservoir computing neural network 616, e.g., enabling the brain emulation reservoir computing neural network 616 to be deployed in resource-constrained environments, e.g., mobile devices. Reducing the complexity of the architecture 602 can also facilitate training of the brain emulation reservoir computing neural network 616, e.g., by reducing the amount of training data required to train the brain emulation reservoir computing neural network 616 to achieve an threshold level of performance (e.g., prediction accuracy).

In some cases, the architecture mapping system 600 can further reduce the complexity of the architecture 602 using a nucleus classification engine 618. In particular, the architecture mapping system 600 can process the sub-graph 612 using the nucleus classification engine 618 prior to determining the architecture 602. The nucleus classification engine 618 can be configured to process a representation of the sub-graph 612 as a two-dimensional array of numerical values (as described above) to identify one or more “clusters” in the array.

A cluster in the array representing the sub-graph 612 may refer to a contiguous region of the array such that at least a threshold fraction of the components in the region have a value indicating that an edge exists between the pair of nodes corresponding to the component. In one example, the component of the array in position (i,j) can have value 1 if an edge exists from node i to node j, and value 0 otherwise. In this example, the nucleus classification engine 618 can identify contiguous regions of the array such that at least a threshold fraction of the components in the region have the value 1. The nucleus classification engine 618 can identify clusters in the array representing the sub-graph 612 by processing the array using a blob detection algorithm, e.g., by convolving the array with a Gaussian kernel and then applying the

Laplacian operator to the array. After applying the Laplacian operator, the nucleus classification engine 618 can identify each component of the array having a value that satisfies a predefined threshold as being included in a cluster.

Each of the clusters identified in the array representing the sub-graph 612 can correspond to edges connecting a “nucleus” (i.e., group) of related neuronal elements in brain, e.g., a thalamic nucleus, a vestibular nucleus, a dentate nucleus, or a fastigial nucleus. After the nucleus classification engine 618 identifies the clusters in the array representing the sub-graph 612, the architecture mapping system 600 can select one or more of the clusters for inclusion in the sub-graph 612. The architecture mapping system 600 can select the clusters for inclusion in the sub-graph 612 based on respective features associated with each of the clusters. The features associated with a cluster can include, e.g., the number of edges (i.e., components of the array) in the cluster, the average of the node features corresponding to each node that is connected by an edge in the cluster, or both. In one example, the architecture mapping system 600 can select a predefined number of largest clusters (i.e., that include the greatest number of edges) for inclusion in the sub-graph 612.

The architecture mapping system 600 can reduce the sub-graph 612 by removing any edge in the sub-graph 612 that is not included in one of the selected clusters, and then map the reduced sub-graph 612 to a corresponding neural network architecture, as will be described in more detail below. Reducing the sub-graph 612 by restricting it to include only edges that are included in selected clusters can further reduce the complexity of the architecture 602, thereby reducing computational resource consumption by the brain emulation reservoir computing neural network 616 and facilitating training of the brain emulation reservoir computing neural network 616.

The architecture mapping system 600 can determine the architecture 602 of the brain emulation reservoir computing neural network 616 from the sub-graph 612 (or from the input graph 601) in any of a variety of ways. For example, the architecture mapping system 600 can map each node in the sub-graph 612 to a corresponding: (i) artificial neuron, (ii) artificial neural network layer, or (iii) group of artificial neural network layers in the architecture 602, as will be described in more detail next.

In one example, the neural network architecture 602 can include: (i) a respective artificial neuron corresponding to each node in the sub-graph 612, and (ii) a respective connection corresponding to each edge in the sub-graph 612. In this example, the sub-graph 612 can be a directed graph, and an edge that points from a first node to a second node in the sub-graph 612 can specify a connection pointing from a corresponding first artificial neuron to a corresponding second artificial neuron in the architecture 602. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the sub-graph. An artificial neuron may refer to a component of the architecture 602 that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the sub-graph 612 can be an undirected graph, and the architecture mapping system 600 can map an edge that connects a first node to a second node in the sub-graph 612 to two connections between a corresponding first artificial neuron and a corresponding second artificial neuron in the architecture. In particular, the architecture mapping system 600 can map the edge to: (i) a first connection pointing from the first artificial neuron to the second artificial neuron, and (ii) a second connection pointing from the second artificial neuron to the first artificial neuron.

In another example, the sub-graph 612 can be an undirected graph, and the architecture mapping system can map an edge that connects a first node to a second node in the sub-graph 612 to one connection between a corresponding first artificial neuron and a corresponding second artificial neuron in the architecture. The architecture mapping system 600 can determine the direction of the connection between the first artificial neuron and the second artificial neuron, e.g., by randomly sampling the direction in accordance with a probability distribution over the set of two possible directions.

In some cases, the edges in the sub-graph 612 is not be associated with weight values, and the weight values corresponding to the connections in the architecture 602 can be determined randomly. For example, the weight value corresponding to each connection in the architecture 602 can be randomly sampled from a predetermined probability distribution, e.g., a standard Normal (N (0,1)) probability distribution.

In another example, the neural network architecture 602 can include: (i) a respective artificial neural network layer corresponding to each node in the sub-graph 612, and (ii) a respective connection corresponding to each edge in the sub-graph 612. In this example, a connection pointing from a first layer to a second layer can indicate that the output of the first layer should be provided as an input to the second layer. An artificial neural network layer may refer to a collection of artificial neurons, and the inputs to a layer and the output generated by the layer can be represented as ordered collections of numerical values (e.g., tensors of numerical values). In one example, the architecture 602 can include a respective convolutional neural network layer corresponding to each node in the sub-graph 612, and each given convolutional layer can generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each edge can be specified by the weight value associated with the corresponding edge in the sub-graph), h_{θ}(108 ) represents the operation of applying one or more convolutional kernels to an input to generate a corresponding output, and σ(108 ) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping system 600 can determine that the neural network architecture includes: (i) a respective group of artificial neural network layers corresponding to each node in the sub-graph 612, and (ii) a respective connection corresponding to each edge in the sub-graph 612. The layers in a group of artificial neural network layers corresponding to a node in the sub-graph 612 can be connected, e.g., as a linear sequence of layers, or in any other appropriate manner.

Various operations performed by the described architecture mapping system 600 are optional or can be implemented in a different order. For example, the architecture mapping system 600 can refrain from applying transformation operations to the graph 601 using the transformation engine 604, and refrain from extracting a sub-graph 612 from the graph 601 using the feature generation engine 606, the node classification engine 608, and the nucleus classification engine 618. In this example, the architecture mapping system 600 can directly map the graph 601 to the neural network architecture 602, e.g., by mapping each node in the graph to an artificial neuron and mapping each edge in the graph to a connection in the architecture, as described above.

FIG. 6B illustrates an example graph 650 and an example sub-graph 652. Each node in the graph 650 is represented by a circle (e.g., 654 and 656), and each edge in the graph 650 is represented by a line (e.g., 658 and 660). In this illustration, the graph 650 can be considered a simplified representation of a synaptic connectivity graph (an actual synaptic connectivity graph can have far more nodes and edges than are depicted in FIG. 6B). A sub-graph 652 can be identified in the graph 650, where the sub-graph 652 includes a proper subset of the nodes and edges of the graph 650. In this example, the nodes included in the sub-graph 652 are hatched (e.g., 656) and the edges included in sub-graph 652 are dashed (e.g., 660). The nodes included in the sub-graph 652 can correspond to neuronal elements of a particular type, e.g., neuronal elements having a particular function, e.g., olfactory neuronal elements, visual neuronal elements, or memory neuronal elements. The architecture of a brain emulation reservoir subnetwork can be specified by the structure of the entire graph 650, or by the structure of a sub-graph 652, as described above.

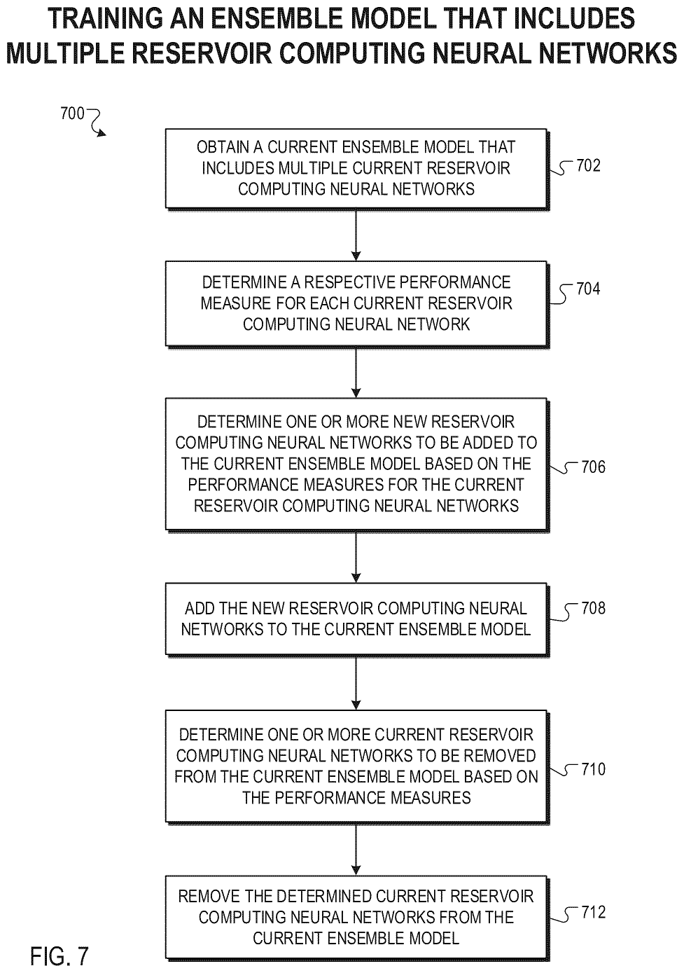

FIG. 7 is a flow diagram of an example process 700 for training an ensemble model that includes multiple reservoir computing neural networks. For convenience, the process 700 will be described as being performed by a system of one or more computers located in one or more locations. For example, an ensemble model training system, e.g., the ensemble model training system 200 described below with reference to FIGS. 2A-2C, appropriately programmed in accordance with this specification, can perform the process 700.

The ensemble model is configured to perform a machine learning task by processing a model input to generate an ensemble model output.

Each of the reservoir computing neural networks are configured to process the model input to generate a respective reservoir computing neural network output. The ensemble model generates the ensemble model output by combining the respective reservoir computing neural network outputs.

The system can repeat the process 700 at each of multiple training stages.

The system obtains a current ensemble model that includes multiple current reservoir computing neural networks (step 702).

The system determines a respective performance measure for each current reservoir computing neural network in the current ensemble model (step 704). The performance measure for each current reservoir computing neural network represents a predicted performance of the current reservoir computing neural network on the machine learning task after the current reservoir computing neural network has been trained to perform the machine learning task.

The system determines one or more new reservoir computing neural networks to be added to the current ensemble model based on the performance measures for the current reservoir computing neural networks (step 706).

The system adds the new reservoir computing neural networks to the current ensemble model (step 708).

The system determines one or more current reservoir computing neural networks in the current ensemble model to be removed from the current ensemble model based on the performance measures for the current reservoir computing neural networks (step 710).

The system removes the determined current reservoir computing neural networks from the current ensemble model (step 712).

After training the ensemble model, the system can deploy the ensemble model in an inference environment, e.g., on the cloud or on a user device.

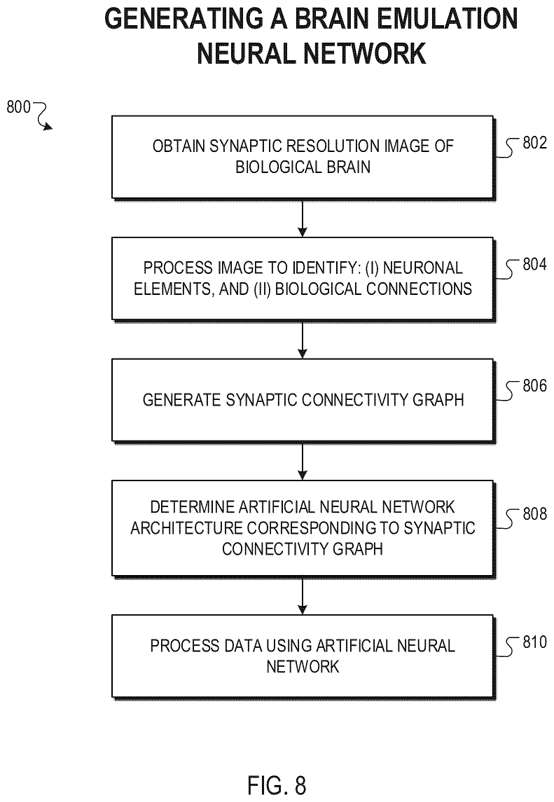

FIG. 8 is a flow diagram of an example process 800 for generating a brain emulation reservoir computing neural network. For convenience, the process 800 will be described as being performed by a system of one or more computers located in one or more locations.

The system obtains a synaptic resolution image of at least a portion of a brain of a biological organism (802).

The system processes the image to identify: (i) neuronal elements in the brain, and (ii) biological connections between the neuronal elements in the brain (804).

The system generates data defining a graph representing biological connectivity between the neuronal elements in the brain (806). The graph includes a set of nodes and a set of edges, where each edge connects a pair of nodes. The system identifies each neuronal element in the brain as a respective node in the graph, and each biological connection between a pair of neuronal elements in the brain as an edge between a corresponding pair of nodes in the graph.

The system determines an artificial neural network architecture corresponding to the graph representing the biological connectivity between the neuronal elements in the brain (808).

The system processes a network input using an artificial neural network having the artificial neural network architecture to generate a network output (810).

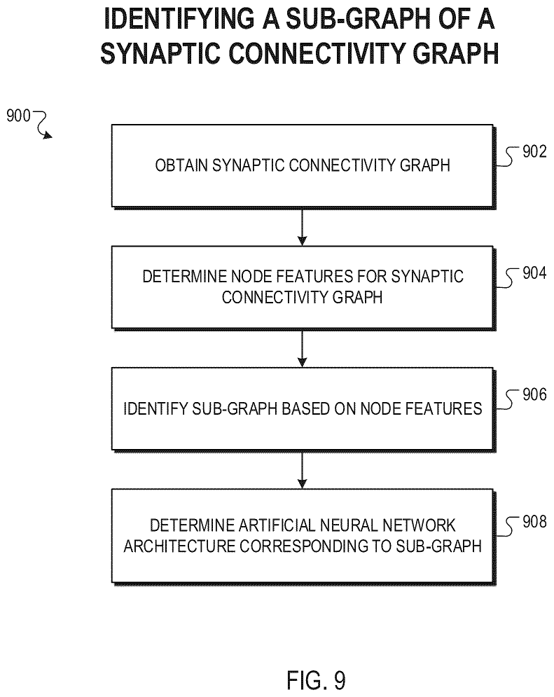

FIG. 9 is a flow diagram of an example process 900 for determining an artificial neural network architecture corresponding to a sub-graph of a synaptic connectivity graph. For convenience, the process 900 will be described as being performed by a system of one or more computers located in one or more locations. For example, an architecture mapping system, e.g., the architecture mapping system 600 of FIG. 6, appropriately programmed in accordance with this specification, can perform the process 900.

The system obtains data defining a graph representing biological connectivity between neuronal elements in a brain of a biological organism (902). The graph includes a set of nodes and edges, where each edge connects a pair of nodes. Each node corresponds to a respective neuronal element in the brain of the biological organism, and each edge connecting a pair of nodes in the graph corresponds to a biological connection between a pair of neuronal elements in the brain of the biological organism.

The system determines, for each node in the graph, a respective set of one or more node features characterizing a structure of the graph relative to the node (904).

The system identifies a sub-graph of the graph (906). In particular, the system selects a proper subset of the nodes in the graph for inclusion in the sub-graph based on the node features of the nodes in the graph.

The system determines an artificial neural network architecture corresponding to the sub-graph of the graph (908).

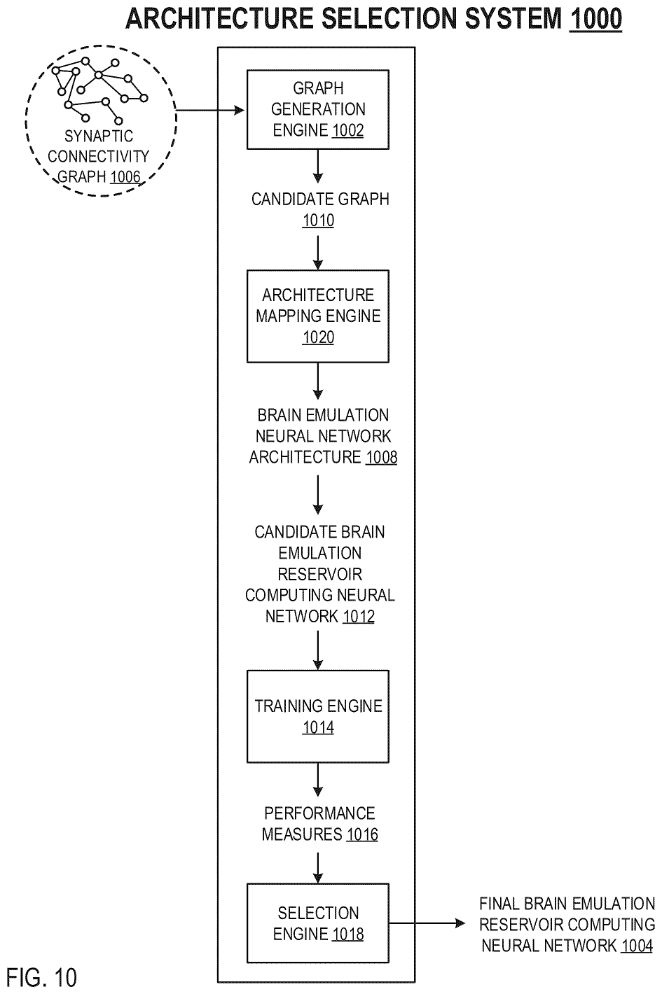

FIG. 10 is an example architecture selection system 1000. The architecture selection system 1000 is an example of a system implemented as computer programs on one or more computers in one or more locations in which the systems, components, and techniques described below are implemented.

The system 1000 is configured to search a space of possible neural network architectures to identify the neural network architecture of a brain emulation reservoir computing neural network 1004 (e.g., the reservoir computing neural networks 110a-n described above with reference to FIG. 1). In some implementations, the system 1000 can identify multiple brain emulation reservoir computing neural networks 1004. The one or more brain emulation reservoir computing neural networks 1004 can then be added to an ensemble model that includes multiple different reservoir computing neural networks (or added to a pool of reservoir computing neural networks from which a training system for the ensemble model samples), as described above.

The system 1000 can seed the search through the space of possible neural network architectures using a synaptic connectivity graph 1006 representing biological connectivity in the brain of a biological organism. The synaptic connectivity graph 1006 may be derived directly from a synaptic resolution image of the brain of a biological organism. In some cases, the synaptic connectivity graph 1006 may be a sub-graph of a larger graph derived from a synaptic resolution image of a brain, e.g., a sub-graph that includes neuronal elements of a particular type, e.g., neuronal elements that process sensory inputs that are of the same type as (or that are otherwise similar to) the input data that the neural network is configured to process.

The system 1000 includes a graph generation engine 1002, an architecture mapping engine 1020, a training engine 1014, and a selection engine 1018, each of which will be described in more detail next.

The graph generation engine 1002 is configured to process the synaptic connectivity graph 1006 to generate multiple “candidate” graphs 1010, where each candidate graph is defined by a set of nodes and a set of edges, such that each edge connects a pair of nodes. The graph generation engine 1002 may generate the candidate graphs 1010 from the synaptic connectivity graph 1006 using any of a variety of techniques. A few examples follow.

In one example, the graph generation engine 1002 may generate a candidate graph 1010 at each of multiple iterations by processing the synaptic connectivity graph 1006 in accordance with current values of a set of graph generation parameters. The current values of the graph generation parameters may specify (transformation) operations to be applied to an adjacency matrix representing the synaptic connectivity graph 1006 to generate an adjacency matrix representing a candidate graph 1010. The operations to be applied to the adjacency matrix representing the synaptic connectivity graph may include, e.g., filtering operations, cropping operations, or both. The candidate graph 1010 may be defined by the result of applying the operations specified by the current values of the graph generation parameters to the adjacency matrix representing the synaptic connectivity graph 1006.

The graph generation engine 1002 may apply a filtering operation to the adjacency matrix representing the synaptic connectivity graph 1006, e.g., by convolving a filtering kernel with the adjacency matrix representing the synaptic connectivity graph. The filtering kernel may be defined by a two-dimensional matrix, where the components of the matrix are specified by the graph generation parameters. Applying a filtering operation to the adjacency matrix representing the synaptic connectivity graph 1006 may have the effect of adding edges to the synaptic connectivity graph 1006, removing edges from the synaptic connectivity graph 1006, or both.

The graph generation engine 1002 may apply a cropping operation to the adjacency matrix representing the synaptic connectivity graph 1006, where the cropping operation replaces the adjacency matrix representing the synaptic connectivity graph 1006 with an adjacency matrix representing a sub-graph of the synaptic connectivity graph 1006. The cropping operation may specify a sub-graph of synaptic connectivity graph 1006, e.g., by specifying a proper subset of the rows and a proper subset of the columns of the adjacency matrix representing the synaptic connectivity graph 1006 that define a sub-matrix of the adjacency matrix. The sub-graph may include: (i) each edge specified by the sub-matrix, and (ii) each node that is connected by an edge specified by the sub-matrix.

At each iteration, the system 1000 determines a performance measure 1016 corresponding to the candidate graph 1010 generated at the iteration, and the system 1000 updates the current values of the graph generation parameters to encourage the generation of candidate graphs 1010 with higher performance measures 1016. The performance measure 1016 for a candidate graph 1010 characterizes the performance of a brain emulation reservoir computing neural network having an architecture specified by the candidate graph 1010 at performing a machine learning task. Determining performance measures 1016 for candidate graphs 1010 will be described in more detail below. The system 1000 may use any appropriate optimization technique to update the current values of the graph generation parameters, e.g., a “black-box” optimization technique that does not rely on computing gradients of the operations performed by the graph generation engine 1002. Examples of black-box optimization techniques which may be implemented by the optimization engine are described with reference to: Golovin, D., Solnik, B Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters may be set to default values or randomly initialized.

In another example, the graph generation engine 1002 may generate the candidate graphs 1010 by “evolving” a population (i.e., a set) of graphs derived from the synaptic connectivity graph 1006 over multiple iterations. The graph generation engine 1002 may initialize the population of graphs, e.g., by “mutating” multiple copies of the synaptic connectivity graph 1006. Mutating a graph refers to making a random change to the graph, e.g., by randomly adding or removing edges or nodes from the graph. After initializing the population of graphs, the graph generation engine 1002 may generate a candidate graph at each of multiple iterations by, at each iteration, selecting a graph from the population of graphs derived from the synaptic connectivity graph and mutating the selected graph to generate a candidate graph 1010. The graph generation engine 1002 may determine a performance measure 1016 for the candidate graph 1010, and use the performance measure to determine whether the candidate graph 1010 is added to the current population of graphs.

In some implementations, each edge of the synaptic connectivity graph may be associated with a weight value that is determined from the synaptic resolution image of the brain, as described above. Each candidate graph may inherit the weight values associated with the edges of the synaptic connectivity graph. For example, each edge in the candidate graph that corresponds to an edge in the synaptic connectivity graph may be associated with the same weight value as the corresponding edge in the synaptic connectivity graph. Edges in the candidate graph that do not correspond to edges in the synaptic connectivity graph may be associated with default or randomly initialized weight values.

In another example, the graph generation engine 1002 can generate each candidate graph 1010 as a sub-graph of the synaptic connectivity graph 1006. For example, the graph generation engine 1002 can randomly select sub-graphs, e.g., by randomly selecting a proper subset of the rows and a proper subset of the columns of the adjacency matrix representing the synaptic connectivity graph 1006 that define a sub-matrix of the adjacency matrix. The sub-graph may include: (i) each edge specified by the sub-matrix, and (ii) each node that is connected by an edge specified by the sub-matrix.

The architecture mapping engine 1020 processes each candidate graph 1010 to generate a corresponding brain emulation neural network architecture 1008. The architecture mapping engine 1020 may use the candidate graph 1010 derived from the synaptic connectivity graph 1006 to specify the brain emulation neural network architecture 1008 in any of a variety of ways. For example, the architecture mapping engine 1020 may map each node in the candidate graph 1010 to a corresponding: (i) artificial neuron, (ii) artificial neural network layer, or (iii) group of artificial neural network layers in the brain emulation neural network architecture 1008, as will be described in more detail next.

In one example, the brain emulation neural network architecture 1008 can include: (i) a respective artificial neuron corresponding to each node in the candidate graph 1010, and (ii) a respective connection corresponding to each edge in the candidate graph 1010. In this example, the graph can be a directed graph, and an edge that points from a first node to a second node in the graph can specify a connection pointing from a corresponding first artificial neuron to a corresponding second artificial neuron in the architecture. The connection pointing from the first artificial neuron to the second artificial neuron can indicate that the output of the first artificial neuron should be provided as an input to the second artificial neuron. Each connection in the architecture can be associated with a weight value, e.g., that is specified by the weight value associated with the corresponding edge in the graph.

An artificial neuron can refer to a component of the architecture that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b by executing equation (1) above.

In another example, the candidate graph 1010 can be an undirected graph, and the architecture mapping engine 1020 can map an edge that connects a first node to a second node in the graph to two connections between a corresponding first artificial neuron and a corresponding second artificial neuron in the architecture. In particular, the architecture mapping engine 1020 can map the edge to: (i) a first connection pointing from the first artificial neuron to the second artificial neuron, and (ii) a second connection pointing from the second artificial neuron to the first artificial neuron.

In another example, the candidate graph 1010 can be an undirected graph, and the architecture mapping engine 1020 can map an edge that connects a first node to a second node in the graph to one connection between a corresponding first artificial neuron and a corresponding second artificial neuron in the architecture. The architecture mapping engine 1020 can determine the direction of the connection between the first artificial neuron and the second artificial neuron, e.g., by randomly sampling the direction in accordance with a probability distribution over the set of two possible directions.

In some cases, the edges in the candidate graph are not associated with weight values, and the weight values corresponding to the connections in the architecture can be determined randomly. For example, the weight value corresponding to each connection in the architecture can be randomly sampled from a predetermined probability distribution, e.g., a standard Normal (N(0,1)) probability distribution.

In another example, the brain emulation neural network architecture 1008 can include: (i) a respective artificial neural network layer corresponding to each node in the candidate graph, and (ii) a respective connection corresponding to each edge in the candidate graph. In this example, a connection pointing from a first layer to a second layer can indicate that the output of the first layer should be provided as an input to the second layer. An artificial neural network layer can refer to a collection of artificial neurons, and the inputs to a layer and the output generated by the layer can be represented as ordered collections of numerical values (e.g., tensors of numerical values). In one example, the architecture can include a respective convolutional neural network layer corresponding to each node in the graph, and each given convolutional layer can generate an output d by executing equation (2) above. In this example, each convolutional kernel can be represented as an array of numerical values, e.g., where each component of the array is randomly sampled from a predetermined probability distribution, e.g., a standard Normal probability distribution.

In another example, the architecture mapping engine 1020 can determine that the brain emulation neural network architecture includes: (i) a respective group of artificial neural network layers corresponding to each node in the graph, and (ii) a respective connection corresponding to each edge in the graph. The layers in a group of artificial neural network layers corresponding to a node in the graph can be connected, e.g., as a linear sequence of layers, or in any other appropriate manner.

The architecture of a brain emulation sub-network can directly represent biological connectivity in a region of the brain of the biological organism. More specifically, the system can map the nodes of the candidate graph (which each represent, e.g., a biological neuronal element in the brain) onto corresponding artificial neurons in the brain emulation sub-network. The system can also map the edges of the candidate graph (which each represent, e.g., a biological connection between a pair of neuronal elements in the brain) onto connections between corresponding pairs of artificial neurons in the brain emulation sub-network. The system can map the respective weight associated with each edge in the candidate graph to a corresponding weight (i.e., parameter value) of a corresponding connection in the brain emulation sub-network. The weight corresponding to an edge (representing, e.g., a biological connection in the brain) between a pair of nodes in the candidate graph (representing a pair of biological neuronal elements in the brain) can represent a proximity of the pair of biological neuronal elements in the brain, as described above.

In some implementations, the architecture mapping system 1020 is an optimization system that is configured to perform an optimization to determine one or more community sub-graphs from the synaptic connectivity graph. The optimization system can then generate the brain emulation reservoir computing neural network from one or more of the determined community sub-graphs. Community sub-graphs are discussed in more detail above with reference to FIG. 4A and in U.S. patent application Ser. No. 17/524,574, which has been incorporated by reference.

For each brain emulation neural network architecture 1008, the training engine 1014 instantiates a candidate brain emulation reservoir computing neural network 1012. The candidate brain emulation reservoir computing neural network 1012 can include a brain emulation sub-network that has the brain emulation neural network architecture 1008 and acts as the reservoir. In some implementations, the candidate brain emulation reservoir computing neural network 1012 can include multiple brain emulation sub-networks. Accordingly, the training engine 1014 can instantiate multiple candidate brain emulation reservoir computing neural networks 1012 having any appropriate configuration of multiple brain emulation sub-networks. In one example, the training engine 1014 can instantiate a candidate brain emulation reservoir computing neural network 1012 having multiple copies of the same brain emulation sub-network. In another example, the training engine 1014 can instantiate a candidate brain emulation reservoir computing neural network 1012 having multiple different brain emulation sub-networks, e.g., multiple sub-networks that are each specified by a different candidate graph 1010. The training engine 1014 can instantiate any appropriate number and configuration of the candidate brain emulation reservoir computing neural networks 1012, including any appropriate number and configuration of brain emulation sub-networks, and evaluate each candidate brain emulation reservoir computing neural network 1012 at the same machine learning task, as will be described in more detail next.

Each candidate brain emulation reservoir computing neural network 1012 is configured to perform a machine learning task, e.g., by processing a network input to generate a corresponding network output that defines a prediction characterizing the network input. The machine learning task can be any appropriate machine learning task, e.g., a classification task, a regression task, a segmentation task, an agent control task, or a combination thereof. The training engine 1014 is configured to train each candidate brain emulation reservoir computing neural network 1012 over one or more training iterations.

The training engine 1014 determines a respective performance measure 1016 of each candidate brain emulation reservoir computing neural network 1012 on the machine learning task. For example, the training engine 1014 can train the candidate brain emulation reservoir computing neural network 1012 on a set of training data over a sequence of training iterations, e.g., using the training engine 316 described with reference to FIG. 3A. The training engine 1014 can then evaluate the performance of the candidate brain emulation reservoir computing neural network 1012 on a set of validation data, e.g., that includes a set of training examples that are part of the training data used to train the candidate brain emulation reservoir computing neural network 1012. The training engine 1014 can evaluate the performance of the candidate brain emulation reservoir computing neural network 1012 on the set of validation data, e.g., by computing an average error (e.g., cross-entropy error or squared-error) in network outputs generated by the neural network for the validation data.

The selection engine 1018 uses the performance measures 1016 to generate the output final brain emulation reservoir computing neural network 1004. In one example, the selection engine 1018 may generate a final brain emulation reservoir computing neural network 1004 having the brain emulation neural network architecture 1008 associated with the best (e.g., highest) performance measure 1016. The final brain emulation reservoir computing neural network 1004 can then be provided to another system for inclusion into an ensemble model, e.g., the evaluation engine 230 described above with reference to FIG. 2C.

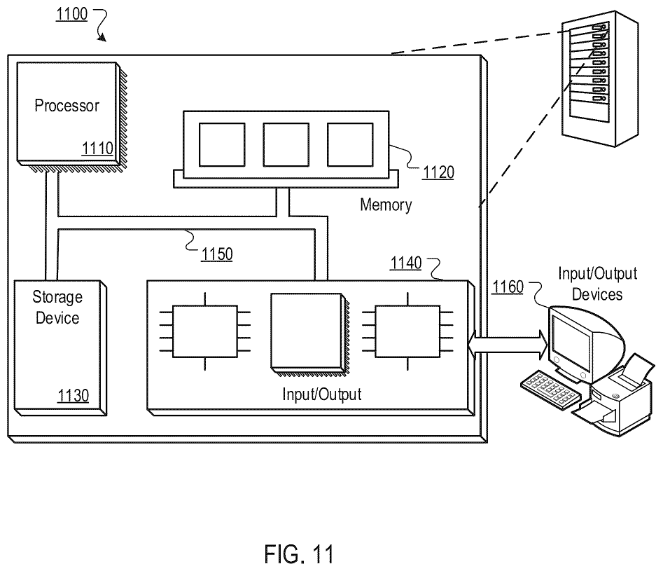

FIG. 11 is a block diagram of an example computer system 1100 that can be used to perform operations described previously. The system 1100 includes a processor 1110, a memory 1120, a storage device 1130, and an input/output device 1140. Each of the components 1110, 1120, 1130, and 1140 can be interconnected, for example, using a system bus 1150. The processor 1110 is capable of processing instructions for execution within the system 1100. In one implementation, the processor 1110 is a single-threaded processor. In another implementation, the processor 1110 is a multi-threaded processor. The processor 1110 is capable of processing instructions stored in the memory 1120 or on the storage device 1130.

The memory 1120 stores information within the system 1100. In one implementation, the memory 1120 is a computer-readable medium. In one implementation, the memory 1120 is a volatile memory unit. In another implementation, the memory 1120 is a non-volatile memory unit.

The storage device 1130 is capable of providing mass storage for the system 1100. In one implementation, the storage device 1130 is a computer-readable medium. In various different implementations, the storage device 1130 can include, for example, a hard disk device, an optical disk device, a storage device that is shared over a network by multiple computing devices (for example, a cloud storage device), or some other large capacity storage device.

The input/output device 1140 provides input/output operations for the system 1100. In one implementation, the input/output device 1140 can include one or more network interface devices, for example, an Ethernet card, a serial communication device, for example, and RS-232 port, and/or a wireless interface device, for example, and 802.11 card. In another implementation, the input/output device 1140 can include driver devices configured to receive input data and send output data to other input/output devices, for example, keyboard, printer and display devices 1160. Other implementations, however, can also be used, such as mobile computing devices, mobile communication devices, and set-top box television client devices.

Although an example processing system has been described in FIG. 11, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a system comprising an ensemble model that has been configured through training to perform a machine learning task by processing a model input to generate an ensemble model output,
the ensemble model comprising a plurality of reservoir computing neural networks that are each configured to process the model input to generate a respective reservoir computing neural network output, wherein the ensemble model generates the ensemble model output by combining the respective reservoir computing neural network outputs,
the ensemble model having been trained by operations comprising, at each training stage in a sequence of training stages:
   obtaining a current ensemble model that comprises a plurality of current reservoir computing neural networks;
   determining a respective performance measure for each current reservoir computing neural network in the current ensemble model, wherein the performance measure for each current reservoir computing neural network represents a predicted performance of the current reservoir computing neural network on the machine learning task after the current reservoir computing neural network has been trained to perform the machine learning task;
   determining one or more new reservoir computing neural networks to be added to the current ensemble model based on the performance measures for the current reservoir computing neural networks; and
   adding the new reservoir computing neural networks to the current ensemble model.

Embodiment 2 is the system of embodiment 1, wherein at each training stage that is after the first training stage in the sequence of training stages, obtaining the current ensemble model comprises:
for each current reservoir computing neural network that was added to the ensemble model at the preceding training stage in the sequence of training stages, training the current reservoir computing neural network to generate trained values for a plurality of trainable parameters of the current reservoir computing neural network; and
for each current reservoir computing neural network that was already in the ensemble model during the preceding training stage in the sequence of training stages, obtaining trained values for a plurality of trainable parameters of the current reservoir computing neural network that were generated at a previous training stage in the sequence of training stages.

Embodiment 3 is the system of any one of embodiments 1 or 2, wherein for each current reservoir computing neural network in the ensemble model, determining the performance measure of the current reservoir computing neural network comprises:
training the current reservoir computing neural network, on a set of training data, to perform the machine learning task;
evaluating a prediction accuracy of the current reservoir computing neural network on a set of validation data; and
determining the performance measure of the current reservoir computing neural network based on the prediction accuracy of the current reservoir computing neural network on the set of validation data.

Embodiment 4 is the system of any one of embodiments 1-3, wherein at each training stage in the sequence of training stages:
the current ensemble model comprises an output layer that comprises a respective output layer parameter corresponding to each current reservoir computing neural network in the current ensemble model;
the output layer of the ensemble model processes the reservoir computing neural network outputs of the reservoir computing neural networks, in accordance with values of the output layer parameters, to generate the ensemble model output; and
obtaining the current ensemble model comprises training the values of the output layer parameters.

Embodiment 5 is the system of embodiment 4, wherein:
determining the respective performance measure for each current reservoir computing neural network comprises, for each current reservoir computing neural network:
   determining the performance measure for the current reservoir computing neural network based on the trained value of the output layer parameter corresponding to the current reservoir computing neural network.

Embodiment 6 is the system of any one of embodiments 1-5, wherein each current reservoir computing neural network comprises a reservoir subnetwork that is configured to process a reservoir subnetwork input, in accordance with values of a set of reservoir subnetwork parameters, to generate a reservoir subnetwork output,
wherein a plurality of the reservoir subnetwork parameters are initialized to static values that are left unchanged during training of the current reservoir computing neural network.

Embodiment 7 is the system of embodiment 6, wherein each current reservoir computing neural network further comprises a decoder subnetwork that is configured to process the reservoir subnetwork output, in accordance with values of a set of decoder subnetwork parameters, to generate the reservoir computing neural network output of the current reservoir computing neural network,
wherein the values of at least some of the decoder subnetwork parameters are iteratively adjusted during training of the current reservoir computing neural network.

Embodiment 8 is the system of any one of embodiments 6 or 7, wherein each current reservoir computing neural network further comprises an encoder subnetwork that is configured to process the model input, in accordance with values of a set of encoder subnetwork parameters, to generate the reservoir subnetwork input,
wherein the values of at least some of the encoder subnetwork parameters are iteratively adjusted during training of the current reservoir computing neural network.

Embodiment 9 is the system of any one of embodiments 6-8, wherein determining one or more new reservoir computing neural networks to be added to the ensemble model based on the performance measures for the current reservoir computing neural networks comprises:
identifying a current reservoir computing neural network in the ensemble model as being a high-performing reservoir computing neural network based on the performance measures;
determining an attribute tensor defining one or more attributes of the reservoir subnetwork included in the high-performing reservoir computing neural network; and
determining a new reservoir computing neural network to be added to the ensemble model based on the attribute tensor.

Embodiment 10 is the system of embodiment 9, wherein determining the new reservoir computing neural network to be added to the ensemble model based on the attribute tensor comprises:
selecting a new reservoir subnetwork, from a set of candidate new reservoir subnetworks, for inclusion in the new reservoir computing neural network based on the attribute tensor of the reservoir subnetwork included in the high-performing reservoir computing neural network.

Embodiment 11 is the system of embodiment 10, wherein selecting the new reservoir subnetwork for inclusion in the new reservoir computing neural network comprises:
determining a respective attribute tensor for each candidate new reservoir subnetwork in the set of possible reservoir subnetworks;
determining, for each candidate new reservoir subnetwork in the set of candidate new reservoir subnetworks, a similarity measure between: (i) the attribute tensor for the candidate new reservoir subnetwork, and (ii) the attribute tensor for the reservoir subnetwork included in the high-performing reservoir computing neural network; and
selecting a candidate new reservoir subnetwork in the set of candidate new reservoir subnetworks for inclusion in the new reservoir computing neural network based on the similarity measures.

Embodiment 12 is the system of any one of embodiments 10 or 11, wherein:
at least a subset of the reservoir computing neural networks in the ensemble model are brain emulation reservoir computing neural networks, each brain emulation reservoir computing neural network having a brain emulation reservoir architecture that comprises a plurality of brain emulation parameters that, when initialized, represent biological connectivity between a plurality of neuronal elements in a brain of a biological organism,
the plurality of brain emulation parameters having been determined from a synaptic connectivity graph that represents the synaptic connectivity between the neuronal elements in the brain of the biological organism, the synaptic connectivity graph comprising (i) a plurality of nodes and (ii) a plurality of edges that each connect a respective pair of nodes, and
at least a subset of the set of candidate new reservoir subnetworks each correspond to a respective sub-graph of the synaptic connectivity graph.

Embodiment 13 is the system of embodiment 12, wherein, for each brain emulation reservoir computing neural network, the plurality of brain emulation parameters representing synaptic connectivity between the plurality of neuronal elements in the brain of the biological organism are arranged in a two-dimensional weight matrix having a plurality of rows and a plurality of columns,
wherein each row and each column of the weight matrix corresponds to a respective neuronal element from the plurality of neuronal elements, and
wherein each brain emulation parameter in the weight matrix corresponds to a respective pair of neuronal elements in the brain of the biological organism, the pair comprising: (i) the neuronal element corresponding to a row of the brain emulation parameter in the weight matrix, and (ii) the neuronal element corresponding to a column of the brain emulation parameter in the weight matrix.

Embodiment 14 is the system of any one of embodiments 12 or 13, wherein at least a subset of the set of candidate new reservoir subnetworks each correspond to a respective community sub-graph of the synaptic connectivity graph, community sub-graph having been generated by determining a partition of the synaptic connectivity graph into a plurality of community sub-graphs by performing an optimization that encourages a higher measure of connectedness between nodes included within each community sub-graph relative to nodes included in different community sub-graphs.

Embodiment 15 is the system of embodiment 14, wherein each of the community sub-graphs is predicted to represent a corresponding community of neuronal elements in the brain of the biological organism.

Embodiment 16 is the system of any one of embodiments 1-15, wherein the ensemble model has been trained by performing operations further comprising, at each training stage in the sequence of training stages:
determining one or more current reservoir computing neural networks of the plurality of current reservoir computing neural networks in the current ensemble model to be removed from the current ensemble model based on the performance measures for the current reservoir computing neural networks; and
removing the determined current reservoir computing neural networks from the current ensemble model.

Embodiment 17 is the system of any one of embodiments 1-16, wherein, for each reservoir computing neural network in the ensemble model:
the performance measure of the reservoir computing neural network comprises a plurality of performance values each corresponding to a different class of model input, wherein the performance value corresponding to a particular class of model input represents a predicted performance of the reservoir computing neural network on the machine learning task when processing model inputs of the particular class.

Embodiment 18 is the system of any one of embodiments 1-17, wherein the ensemble model has been trained by performing operations further comprising, at each of one or more training stages in the sequence of training stages:
determining one or more new reservoir computing neural networks at random and adding the randomly-determined new reservoir computing neural networks to the current ensemble model.

Embodiment 19 is a method comprising the operations of the system of any one of embodiments 1 to 18.

Embodiment 20 is one or more non-transitory computer storage media encoded with a computer program, the program comprising instructions that are operable, when executed by data processing apparatus, to cause the data processing apparatus to perform the operations of the system of any one of embodiments 1 to 18.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A system comprising an ensemble model that has been configured through training to perform a machine learning task by processing a model input to generate an ensemble model output,
the ensemble model comprising a plurality of reservoir computing neural networks that are each configured to process the model input to generate a respective reservoir computing neural network output, wherein the ensemble model generates the ensemble model output by combining the respective reservoir computing neural network outputs,
the ensemble model having been trained by operations comprising, at each training stage in a sequence of training stages:
obtaining a current ensemble model that comprises a plurality of current reservoir computing neural networks;
determining a respective performance measure for each current reservoir computing neural network in the current ensemble model, wherein the performance measure for each current reservoir computing neural network represents a predicted performance of the current reservoir computing neural network on the machine learning task after the current reservoir computing neural network has been trained to perform the machine learning task;
determining one or more new reservoir computing neural networks to be added to the current ensemble model based on the performance measures for the current reservoir computing neural networks; and
adding the new reservoir computing neural networks to the current ensemble model.

2. The system of claim 1, wherein at each training stage that is after the first training stage in the sequence of training stages, obtaining the current ensemble model comprises:
for each current reservoir computing neural network that was added to the ensemble model at the preceding training stage in the sequence of training stages, training the current reservoir computing neural network to generate trained values for a plurality of trainable parameters of the current reservoir computing neural network; and
for each current reservoir computing neural network that was already in the ensemble model during the preceding training stage in the sequence of training stages, obtaining trained values for a plurality of trainable parameters of the current reservoir computing neural network that were generated at a previous training stage in the sequence of training stages.

3. The system of claim 1, wherein for each current reservoir computing neural network in the ensemble model, determining the performance measure of the current reservoir computing neural network comprises:
training the current reservoir computing neural network, on a set of training data, to perform the machine learning task;
evaluating a prediction accuracy of the current reservoir computing neural network on a set of validation data; and
determining the performance measure of the current reservoir computing neural network based on the prediction accuracy of the current reservoir computing neural network on the set of validation data.

4. The system of claim 1, wherein at each training stage in the sequence of training stages:
the current ensemble model comprises an output layer that comprises a respective output layer parameter corresponding to each current reservoir computing neural network in the current ensemble model;
the output layer of the ensemble model processes the reservoir computing neural network outputs of the reservoir computing neural networks, in accordance with values of the output layer parameters, to generate the ensemble model output; and
obtaining the current ensemble model comprises training the values of the output layer parameters.

5. The system of claim 4, wherein:
determining the respective performance measure for each current reservoir computing neural network comprises, for each current reservoir computing neural network:
determining the performance measure for the current reservoir computing neural network based on the trained value of the output layer parameter corresponding to the current reservoir computing neural network.

6. The system of claim 1, wherein each current reservoir computing neural network comprises a reservoir subnetwork that is configured to process a reservoir subnetwork input, in accordance with values of a set of reservoir subnetwork parameters, to generate a reservoir subnetwork output,
wherein a plurality of the reservoir subnetwork parameters are initialized to static values that are left unchanged during training of the current reservoir computing neural network.

7. The system of claim 6, wherein each current reservoir computing neural network further comprises a decoder subnetwork that is configured to process the reservoir subnetwork output, in accordance with values of a set of decoder subnetwork parameters, to generate the reservoir computing neural network output of the current reservoir computing neural network,
wherein the values of at least some of the decoder subnetwork parameters are iteratively adjusted during training of the current reservoir computing neural network.

8. The system of claim 6, wherein each current reservoir computing neural network further comprises an encoder subnetwork that is configured to process the model input, in accordance with values of a set of encoder subnetwork parameters, to generate the reservoir subnetwork input,
wherein the values of at least some of the encoder subnetwork parameters are iteratively adjusted during training of the current reservoir computing neural network.

9. The system of claim 6, wherein determining one or more new reservoir computing neural networks to be added to the ensemble model based on the performance measures for the current reservoir computing neural networks comprises:
identifying a current reservoir computing neural network in the ensemble model as being a high-performing reservoir computing neural network based on the performance measures;
determining an attribute tensor defining one or more attributes of the reservoir subnetwork included in the high-performing reservoir computing neural network; and
determining a new reservoir computing neural network to be added to the ensemble model based on the attribute tensor.

10. The system of claim 9, wherein determining the new reservoir computing neural network to be added to the ensemble model based on the attribute tensor comprises:
selecting a new reservoir subnetwork, from a set of candidate new reservoir subnetworks, for inclusion in the new reservoir computing neural network based on the attribute tensor of the reservoir subnetwork included in the high-performing reservoir computing neural network.

11. The system of claim 10, wherein selecting the new reservoir subnetwork for inclusion in the new reservoir computing neural network comprises:
determining a respective attribute tensor for each candidate new reservoir subnetwork in the set of possible reservoir subnetworks;
determining, for each candidate new reservoir subnetwork in the set of candidate new reservoir subnetworks, a similarity measure between: (i) the attribute tensor for the candidate new reservoir subnetwork, and (ii) the attribute tensor for the reservoir subnetwork included in the high-performing reservoir computing neural network; and
selecting a candidate new reservoir subnetwork in the set of candidate new reservoir subnetworks for inclusion in the new reservoir computing neural network based on the similarity measures.

12. The system of claim 10, wherein:
at least a subset of the reservoir computing neural networks in the ensemble model are brain emulation reservoir computing neural networks, each brain emulation reservoir computing neural network having a brain emulation reservoir architecture that comprises a plurality of brain emulation parameters that, when initialized, represent biological connectivity between a plurality of neuronal elements in a brain of a biological organism,
the plurality of brain emulation parameters having been determined from a synaptic connectivity graph that represents the synaptic connectivity between the neuronal elements in the brain of the biological organism, the synaptic connectivity graph comprising (i) a plurality of nodes and (ii) a plurality of edges that each connect a respective pair of nodes, and
at least a subset of the set of candidate new reservoir subnetworks each correspond to a respective sub-graph of the synaptic connectivity graph.

13. The system of claim 12, wherein, for each brain emulation reservoir computing neural network, the plurality of brain emulation parameters representing synaptic connectivity between the plurality of neuronal elements in the brain of the biological organism are arranged in a two-dimensional weight matrix having a plurality of rows and a plurality of columns,
wherein each row and each column of the weight matrix corresponds to a respective neuronal element from the plurality of neuronal elements, and
wherein each brain emulation parameter in the weight matrix corresponds to a respective pair of neuronal elements in the brain of the biological organism, the pair comprising: (i) the neuronal element corresponding to a row of the brain emulation parameter in the weight matrix, and (ii) the neuronal element corresponding to a column of the brain emulation parameter in the weight matrix.

14. The system of claim 12, wherein at least a subset of the set of candidate new reservoir subnetworks each correspond to a respective community sub-graph of the synaptic connectivity graph, community sub-graph having been generated by determining a partition of the synaptic connectivity graph into a plurality of community sub-graphs by performing an optimization that encourages a higher measure of connectedness between nodes included within each community sub-graph relative to nodes included in different community sub-graphs.

15. The system of claim 14, wherein each of the community sub-graphs is predicted to represent a corresponding community of neuronal elements in the brain of the biological organism.

16. The system of claim 1, wherein the ensemble model has been trained by performing operations further comprising, at each training stage in the sequence of training stages:
determining one or more current reservoir computing neural networks of the plurality of current reservoir computing neural networks in the current ensemble model to be removed from the current ensemble model based on the performance measures for the current reservoir computing neural networks; and
removing the determined current reservoir computing neural networks from the current ensemble model.

17. The system of claim 1, wherein, for each reservoir computing neural network in the ensemble model:
the performance measure of the reservoir computing neural network comprises a plurality of performance values each corresponding to a different class of model input, wherein the performance value corresponding to a particular class of model input represents a predicted performance of the reservoir computing neural network on the machine learning task when processing model inputs of the particular class.

18. The system of claim 1, wherein the ensemble model has been trained by performing operations further comprising, at each of one or more training stages in the sequence of training stages:
determining one or more new reservoir computing neural networks at random and adding the randomly-determined new reservoir computing neural networks to the current ensemble model.

19. A method comprising:
executing an ensemble model that has been configured through training to perform a machine learning task by processing a model input to generate an ensemble model output,
the ensemble model comprising a plurality of reservoir computing neural networks that are each configured to process the model input to generate a respective reservoir computing neural network output, wherein the ensemble model generates the ensemble model output by combining the respective reservoir computing neural network outputs,
the ensemble model having been trained by operations comprising, at each training stage in a sequence of training stages:
obtaining a current ensemble model that comprises a plurality of current reservoir computing neural networks;
determining a respective performance measure for each current reservoir computing neural network in the current ensemble model, wherein the performance measure for each current reservoir computing neural network represents a predicted performance of the current reservoir computing neural network on the machine learning task after the current reservoir computing neural network has been trained to perform the machine learning task;
determining one or more new reservoir computing neural networks to be added to the current ensemble model based on the performance measures for the current reservoir computing neural networks; and
adding the new reservoir computing neural networks to the current ensemble model.

20. One or more non-transitory storage media storing instructions that when executed by one or more computers cause the one or more computers to perform operations of an ensemble model that has been configured through training to perform a machine learning task by processing a model input to generate an ensemble model output,
the ensemble model comprising a plurality of reservoir computing neural networks that are each configured to process the model input to generate a respective reservoir computing neural network output, wherein the ensemble model generates the ensemble model output by combining the respective reservoir computing neural network outputs,
the ensemble model having been trained by training operations comprising, at each training stage in a sequence of training stages:
obtaining a current ensemble model that comprises a plurality of current reservoir computing neural networks;
determining a respective performance measure for each current reservoir computing neural network in the current ensemble model, wherein the performance measure for each current reservoir computing neural network represents a predicted performance of the current reservoir computing neural network on the machine learning task after the current reservoir computing neural network has been trained to perform the machine learning task;
determining one or more new reservoir computing neural networks to be added to the current ensemble model based on the performance measures for the current reservoir computing neural networks; and
adding the new reservoir computing neural networks to the current ensemble model.
